(19) United States
(12) Patent Application Publication
(10) Pub. No.: US 2026/0300529 A1
(43) Pub. Date: Oct. 1, 2026

(54) SYSTEMS AND METHODS FOR APPLICATION SECURITY ASSESSMENT

(71) Applicant: The PNC Financial Services Group, Inc., Pittsburgh, PA (US)

(72) Inventor: Kevin BURGIN, Medina, OH (US)

(73) Assignee: The PNC Financial Services Group, Inc., Pittsburgh, PA (US)

(21) Appl. No.: 19/306,025

(22) Filed: Aug. 21, 2025

Related U.S. Application Data
(60) Provisional application No. 63/780,886, filed on Mar. 31, 2025.

(51) Int. Cl. G06F 21/62; G06F 21/57

(52) U.S. Cl. CPC G06F 21/6227; G06F 21/577; G06F 21/6272

(57) ABSTRACT

Systems and methods are provided for assessing application security hygiene. Some embodiments involve receiving a plurality of security assessment data elements and a plurality of security assessment metadata elements correlated with the security assessment data elements. Some embodiments involve normalizing the plurality of security assessment data elements to fit a set of uniform security data assessment criteria. Some embodiments involve receiving a plurality of application metadata elements. Some embodiments involve retrieving a plurality of dashboard data from a database. Some embodiments involve retrieving a plurality of tabulated scores. Some embodiments involve retrieving application score history from the database. Some embodiments involve, in response to the normalizing, calculating a security assessment score. Some embodiments involve sending the security assessment score and the plurality of dashboard data over a network for display on a graphical user interface associated with a user device.

### CROSS REFERENCE TO RELATED APPLICATIONS

This application claims the benefit of priority of U.S. Provisional Patent Application No. 63/780,886 filed on Mar. 31, 2025, the contents of which are incorporated herein by reference in their entirety.

### BACKGROUND

The present disclosure relates generally to systems and methods for assessing application security. Application security assessment may refer to the evaluation of an application's security posture to identify potential vulnerabilities and risks that could compromise the application, such as its integrity, confidentiality, or availability.

Application security assessment may be enhanced by receiving and correlating security assessment data and metadata from various source systems, normalizing the data to fit uniform criteria, and calculating a security assessment score based on the prepared set of security assessment criteria.

Organizations may host a large number of applications that may be susceptible to sources of risk from confidentiality, integrity, or availability issues, such as theft or misuse of sensitive data, regulatory non-compliance, service unavailability, and the like. Several issues associated with an application may be unique to its relationship with the internet or with the electronic hosting of sensitive information. Other issues may be unique to users'consistent reliance on application availability, which creates security-related challenges unique to electronic applications. Mitigation of such issues may be one major goal of some applications hosted by the organization or may be of relatively minimal importance to a given application. Nevertheless, an organization aiming to minimize risk may desire that all its applications lower their susceptibility to risk and related security issues. Organizations may, however, have difficulty understanding the security posture associated with applications they host, especially if security mitigation is not an application's goal. What is needed is a security assessment and display mechanism that allows an organization to understand sources of risk associated with an application. Using the security assessment and display mechanism, the organization can take steps to understand the security hygiene and address significant issues, which may involve mitigating overall risks. In some instances, simply knowing of the existence and severity of security issues may significantly impact an organization's ability to address risks.

Disclosed are systems and methods for application security assessment. These systems and methods may involve evaluating, processing, and visualizing application security data to efficiently monitor and manage organizational security posture in real-time. They may also provide an interactive visual tool for real-time security assessment.

### SUMMARY

Systems and methods are provided for assessing application security. Some embodiments involve receiving a plurality of application security assessment data elements from one or more source systems based on a prepared set of security assessment criteria. Some embodiments involve receiving a plurality of security assessment metadata elements correlated with the plurality of application security assessment data elements. Some embodiments involve correlating the plurality of security assessment data elements and the plurality of security assessment metadata elements with an application based on the prepared set of security assessment criteria. Some embodiments involve normalizing the plurality of security assessment data elements to fit a set of uniform security data assessment criteria. Some embodiments involve requesting a plurality of application metadata elements from the application, the application metadata elements including one or more data elements chosen from the set of: information technology service management data elements, identity and access management data elements, or third-party management data elements. Some embodiments involve receiving the plurality of application metadata elements from the application in response to the request. Some embodiments involve retrieving a plurality of dashboard data from a database, the plurality of dashboard data being associated with the prepared set of security assessment criteria. Some embodiments involve retrieving a plurality of tabulated scores from the database, the plurality of tabulated scores being associated with the application and with the prepared set of security assessment criteria. Some embodiments involve retrieving a score history from the database, the score history being associated with the application. Some embodiments involve, in response to the correlating and the normalizing, calculating a security assessment score from the plurality of security assessment data elements, the plurality of security assessment metadata elements, the application metadata elements, the plurality of tabulated scores, and the score history based on the prepared set of security assessment criteria. Some embodiments involve sending the security assessment score and the plurality of dashboard data over a network for display on a graphical user interface associated with a user device.

Some embodiments involve sending for display on a user device a graphical user interface including a plurality of normalized security assessment data elements, a plurality of security assessment metadata elements correlated with the plurality of normalized security assessment data elements, a plurality of application metadata elements associated with an application, a plurality of tabulated scores associated with the application and with a prepared set of security assessment criteria, a graphical representation of at least one of the plurality of tabulated scores, and a security assessment score calculated based on the plurality of normalized security assessment data elements, the plurality of security assessment metadata elements, the plurality of application metadata elements, and the plurality of tabulated scores.

Some embodiments involve receiving a plurality of security assessment scores calculated based on a plurality of normalized security assessment data elements, a plurality of security assessment metadata elements correlated with the plurality of normalized security assessment data elements, a plurality of tabulated scores, and a score history; receiving a plurality of application metadata elements correlated with the plurality of security assessment scores; and sending for display on a user device a graphical user interface including a graphical representation of a subset of the plurality of security assessment scores based on a correlation between the plurality of security assessment scores and the plurality of application metadata elements, and at least one configuration option configured to permit modification of the correlation and configured to permit selection of at least one of the plurality of application metadata elements.

Throughout, this disclosure the phrase “disclosed embodiments,” refers to examples of inventive ideas, concepts, and/or manifestations described herein. Many related and unrelated embodiments are described throughout this disclosure. The fact that some “disclosed embodiments” are described as exhibiting a feature or characteristic does not mean that other disclosed embodiments necessarily share that feature or characteristic. Likewise, the fact that some “disclosed embodiments” are described as exhibiting a feature or characteristic does not mean that other disclosed embodiments cannot share that feature or characteristic.

It is to be understood that both the foregoing general description and the following detailed description are exemplary and explanatory only, and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments.

FIG. 1 is a schematic diagram of members of an institution expressing their desire to improve application security technology, consistent with some disclosed embodiments.

FIG. 2 is a schematic diagram of members of an institution expressing a solution, consistent with some disclosed embodiments.

FIG. 3 shows an exemplary system dedicated to application security assessment, consistent with some disclosed embodiments.

FIG. 4 shows an exemplary computing device dedicated to application security assessment, consistent with some disclosed embodiments.

FIG. 5 is a schematic diagram of exemplary components of a security assessment environment, consistent with some disclosed embodiments.

FIG. 6 is a schematic diagram showing subcomponents of the security assessment system, consistent with some disclosed embodiments.

FIG. 7 shows an exemplary process for application security assessment, consistent with some disclosed embodiments.

FIG. 8 shows an exemplary process for data collection and correlation, consistent with some disclosed embodiments.

FIG. 9 shows an exemplary process for data standardization, consistent with some disclosed embodiments.

FIG. 10 shows an exemplary process for application metadata collection, consistent with some disclosed embodiments.

FIG. 11 shows an exemplary process for accessing stored security assessment data, consistent with some disclosed embodiments.

FIG. 12 shows an exemplary process for security assessment score computation, consistent with some disclosed embodiments.

FIG. 13 shows an exemplary process for dashboard data processing and visualization, consistent with some disclosed embodiments.

FIG. 14 illustrates an exemplary flow diagram for application security assessment, consistent with some disclosed embodiments.

FIGS. 15A-15F illustrate exemplary user interfaces for displaying and interacting with application security assessments, consistent with some disclosed embodiments.

FIG. 16 illustrates an exemplary methodology for application security assessment, consistent with some disclosed embodiments.

FIG. 17 illustrates an exemplary user interface for multi-application comparison view, consistent with some disclosed embodiments.

FIGS. 18A-B is a flow chart of example application security assessment operations, consistent with some disclosed embodiments.

FIG. 19 is a flow chart of example graphical user interface operations for security assessment display, consistent with some disclosed embodiments.

### DETAILED DESCRIPTION

In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence or constrained to a particular system configuration. Additionally, some of the described embodiments or elements thereof can occur or be performed simultaneously, at the same point in time, or concurrently.

Reference will now be made in detail to exemplary embodiments, discussed with reference to the accompanying drawings. Unless otherwise stated, technical and/or scientific terms have the meaning commonly understood by one of ordinary skill in the art. The disclosed embodiments are described in sufficient detail to enable those skilled in the art to practice the disclosed embodiments. It is to be understood that other embodiments may be implemented and that changes may be made without departing from the scope of the disclosed embodiments. For example, unless otherwise indicated, method steps disclosed in the figures may be rearranged, combined, or divided without departing from the envisioned embodiments. Phrases that tend to indicate an order of events, such as “before,” “prior to,” then,” “after,” and the like are not intended to be limiting. Similarly, additional steps may be added, or steps may be removed, without departing from the envisioned embodiments. Thus, the materials, methods, and examples are illustrative only and are not intended to be necessarily limited.

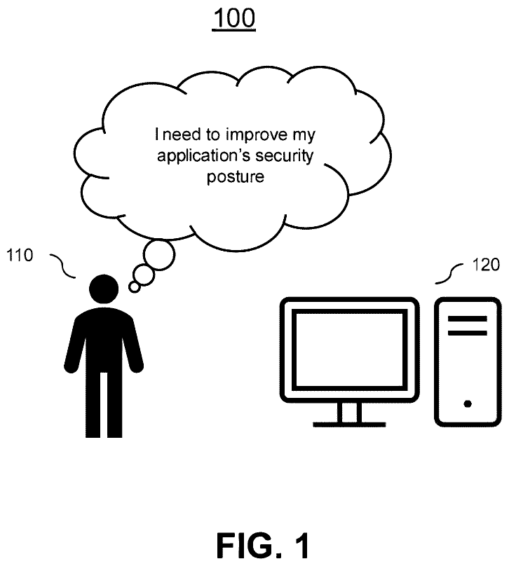

Referring to FIG. 1, an exemplary system environment 100 is shown according to disclosed embodiments. System environment 100 may include an administrator 110 and a computing device 120 hosting an application. The administrator 110 may express a desire to improve their application's security posture. The system environment 100 may also involve receiving a plurality of security assessment data elements from one or more source systems based on a prepared set of security assessment criteria. These criteria may be used to evaluate the security hygiene of the application, including factors such as open issues, policy exceptions, vulnerabilities, incidents, and third-party engagements.

Conventional security assessment approaches may suffer from limitations when attempting to aggregate such diverse security data. Traditional systems typically require manual correlation of data from disparate source systems, each of which may use different formats, such as severity scales, assessment criteria, and security data. This fragmentation may result in delayed security insights, inconsistent risk scoring across applications, and an inability to provide real-time comprehensive visibility into an application's security posture. Furthermore, conventional systems may lack a unified dashboard presentation, forcing administrators to navigate multiple interfaces and manually compile reports, thereby increasing the likelihood of overlooking critical security issues and impeding effective prioritization of remediation efforts. The systems and methods disclosed herein may provide one or more improvements over conventional systems as explained in further detail.

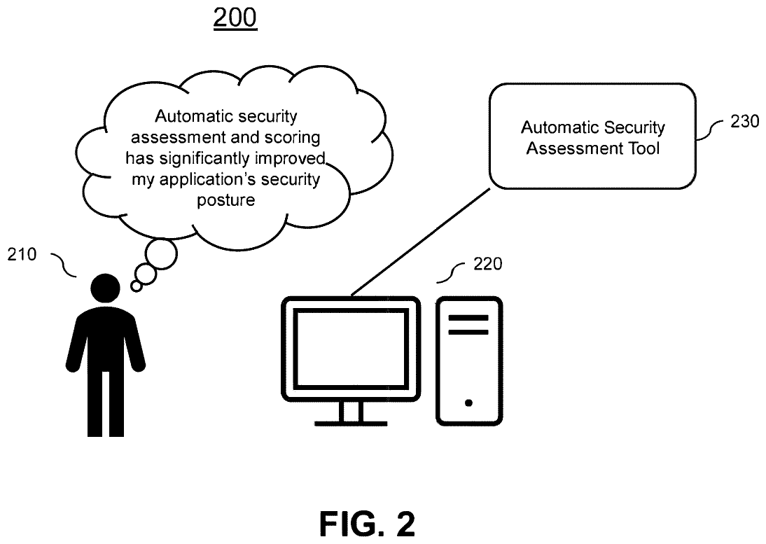

Turning to FIG. 2, an exemplary system environment 200 is shown according to disclosed embodiments. System environment 200 may include an administrator 210, a computing device 220 hosting an application, and an automatic security assessment tool 230. In some embodiments, the automatic security assessment tool 230 may be used to enhance application security. For example, the automatic security assessment tool 230 may be used to monitor, detect, and/or respond to security vulnerabilities, policy exceptions, incidents, third-party engagements; etc. Additionally, the system environment 200 may involve calculating a security assessment score from the plurality of security assessment data elements, security assessment metadata elements, application metadata elements, tabulated scores, and score history based on the prepared set of security assessment criteria. This score may provide a numerical value indicating the security hygiene or quality of risk management of the application.

The calculated security assessment score may enable automated prioritization of remediation efforts by mathematically ranking applications based on their scores and the severity of their security deficiencies. The score calculation process may transform diverse security indicators into actionable metrics. The score's presentation through dashboard interfaces may enable real-time monitoring of security posture changes and automated resource allocation decisions. The systematic processing of security data from disparate sources through correlation, normalization, and calculation operations may transforms raw security information into quantified assessments that drive organizational security improvements.

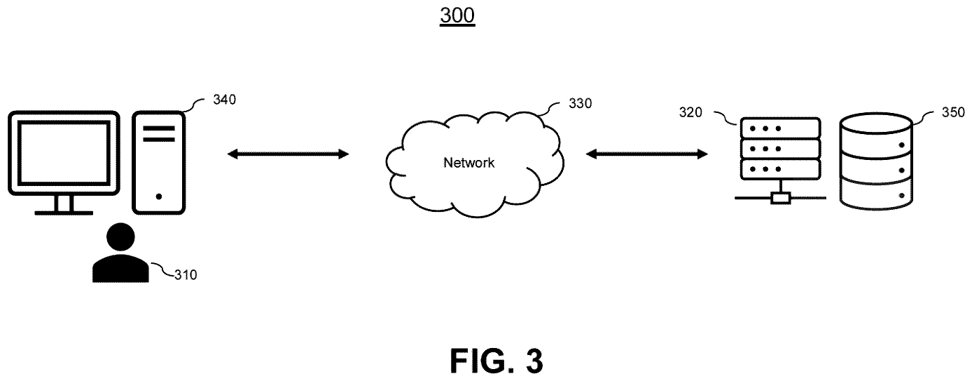

Referring to FIG. 3, an exemplary system environment 300 is disclosed, consistent with some disclosed embodiments. System environment 300 may include one or more endpoint devices 340, which may be operated by administrator 310, which may correspond to administrator 210. System environment 300 may further include one or more computing devices 320, a network 330, and one or more databases 350.

The various components of system environment 300 may communicate over a network 330. Such communications may take place across various types of networks, such as the Internet, a wired Wide Area Network (WAN), a wired Local Area Network (LAN), a wireless WAN (e.g., WiMAX), a wireless LAN (e.g., IEEE 802.11), a mesh network, a mobile/cellular network, an enterprise or private data network, a storage area network, a virtual private network using a public network, a nearfield communications technique (e.g., Bluetooth, infrared), or various other types of network communications. In some embodiments, the network communications may take place across two or more of these forms of networks and protocols. While system environment 300 is shown as a network-based environment, it is understood that in some embodiments, one or more aspects of the disclosed systems and methods may also be used in a localized system, with one or more of the components communicating directly with each other.

Administrator 310 may serve as a security operations professional, compliance officer, application owner, or other authorized personnel responsible for monitoring and managing application security posture. Administrator 310 may possess varying levels of access privileges within the security assessment system, ranging from read-only access for viewing security scores and dashboards to full administrative rights for configuring assessment criteria, managing user permissions, and initiating remediation workflows.

Computing device 320 may include any form of remote computing device configured to receive, store, and transmit data. For example, computing device 320 may be a server configured to store files accessible through a network (e.g., a web server, application server, virtualized server, etc.). Computing device 320 may interact with a database 350, for example, a loan information database, to receive and/or store information.

One or more endpoint devices 340 may serve as the primary interface for users to access and interact with the security assessment system. Endpoint devices 340 may include desktop workstations, laptop computers, tablets, smartphones, thin clients, or other computing devices capable of displaying graphical user interfaces and processing security assessment data. Endpoint devices 340 may execute web browsers, dedicated security assessment applications, or other client software configured to communicate with the security assessment system through secure protocols. Each endpoint device 340 may include input/output capabilities such as displays for viewing security dashboards, keyboards and pointing devices for user interaction, and network interfaces for transmitting and receiving security assessment data,

Database 350 may be included on a volatile or non-volatile, magnetic, semiconductor, tape, optical, removable, non-removable, or other type of storage device or tangible or non-transitory computer-readable medium. Database 350 may also be part of computing device 320 or separate from computing device 320. When database 350 is not part of computing device 320, computing device 320 may exchange data with database 350 via a communication link. Database 350 may include one or more memory devices that store data and instructions used to perform one or more features of the disclosed embodiments. Database 350 may include any suitable databases, ranging from small databases hosted on a workstation to large databases distributed among data centers. Database 350 may also include any combination of one or more databases controlled by memory controller devices (e.g., server(s)) or software. For example, database 350 may include document management systems, Microsoft SQL™ databases, SharePoint™ databases, Oracle™ databases, Sybase™ databases, other relational databases, or non-relational databases, such as mongo and others. Although one database 350 is shown in FIG. 3, system environment 300 may include one or more databases 350, which may be used to store various types of security-sensitive information associated with applications.

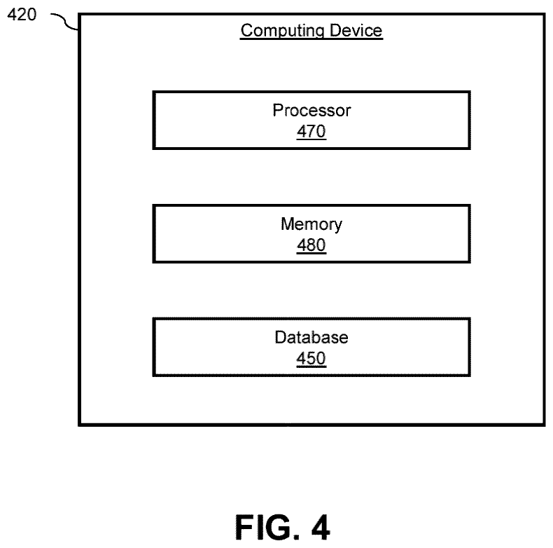

FIG. 4 is a block diagram showing an example computing device 420, which may correspond to computing device 320 from FIG. 3, consistent with the disclosed embodiments. As described above, computing device 420 may be one or more devices configured to allow data to be received and/or transmitted by system environment 300 (e.g., a server) and may include one or more dedicated processors and/or memories. For example, computing device 420 may include a processor (or multiple processors) 470, a memory (or multiple memories) 480, and a database 450, which may correspond to database 350 shown in FIG. 3. Computing device 420 may include one or more digital and/or analog devices that may allow computing device 420 to communicate with other machines and devices, such as other components of system 300 shown in FIG. 3. Computing device 420 may include one or more input/output devices. Computing device 420 may include a screen for displaying communications to a user. In some embodiments computing device 420 may include a touch screen. Computing device 420 may include other components known in the art for interacting with a user. Computing device 420 may also include one or more digital and/or analog devices that may allow a user to interact with system 300, such as touch-sensitive area, keyboard, buttons, or microphones.

Processor 470 may take the form of, but is not limited to, one or more integrated circuits (IC), including application-specific integrated circuit (ASIC), microchips, microcontrollers, microprocessors, embedded processor, all or part of a central processing unit (CPU), graphics processing unit (GPU), digital signal processor (DSP), field-programmable gate array (FPGA), server, virtual server, system on an chip (SOC) or other circuits suitable for executing instructions or performing logic operations.. Furthermore, according to some embodiments, processor 470 may be from the family of processors manufactured by Intel®, AMD®, Qualcomm®, Apple®, NVIDIA®, or the like. Processor 470 may also include a mobile processor, a graphics processing unit, etc. The disclosed embodiments are not limited to any type of processor configured in computing device 420. In some embodiments, processor 470 may be a special purpose processor configured to perform one or more of the operations described below.

Memory 480 may include one or more storage devices configured to store instructions used by processor 470 to perform functions related to computing device 420. The disclosed embodiments are not limited to particular software programs or devices configured to perform dedicated tasks. For example, memory 480 may store a single program, such as a user-level application, that performs the functions associated with the disclosed embodiments or may include multiple software programs. Additionally, processor 470 may, in some embodiments, execute one or more programs (or portions thereof) remotely located from computing device 420. Furthermore, memory 480 may include one or more storage devices configured to store data for use by the programs. Memory 480 may include, but is not limited to a hard drive, a solid-state drive, a CD-ROM drive, a peripheral storage device (e.g., an external hard drive, a USB drive, etc.), a network drive, a cloud storage device, or any other storage device.

Computing device 420 may include a database 450 as described above. Database 450 may also be part of computing device 420 or separate from computing device 420. In some embodiments, computing device 420 may include one or more input/output devices, communications devices, displays, and/or other interfaces (e.g., server-to-server, database to-to-database, or other network connections). One or more of endpoint devices 340 may include components similar to those discussed with respect to computing device 420 and may perform functions similar to or different from those described above with respect to computing device 420.

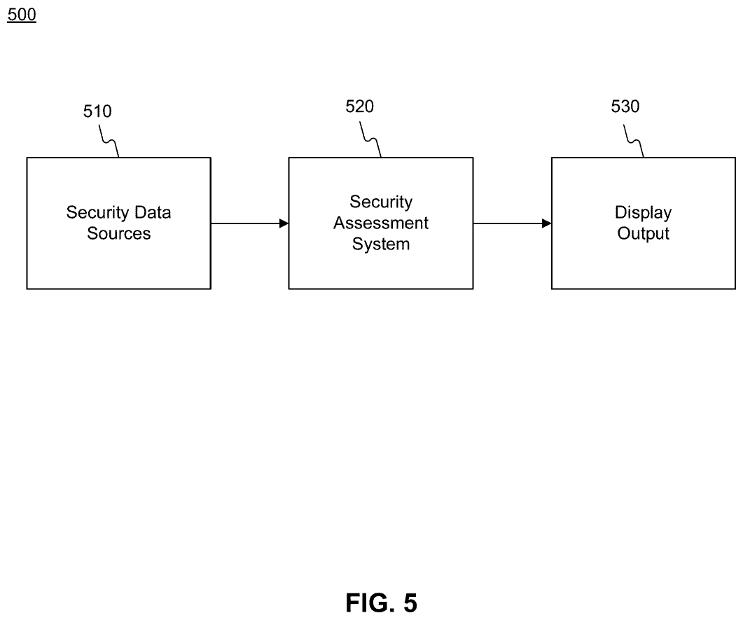

FIG. 5 is a schematic diagram of exemplary components of a security assessment environment 500, consistent with some disclosed embodiments. As shown in the figure, the environment may include security data sources 510, security assessment system 520, and display output 530.

Security data sources 510 may include various data sources including an information technology service management (ITSM) system; a governance, risk, and compliance (GRC) system; a third-party risk management (TPRM) system; or an identity management system. Such systems may be responsible for separately managing and controlling security data associated with an application. ITSM systems may include data related to application inventory information and service and incident information. For example, source systems may collect ITSM data from application inventory information systems. GRC systems may include issue management systems, policy exceptions systems, vulnerability management systems, and risk and data elements systems. These data may be collected from internal databases, systems, or processes. TPRM systems may include third-party inventory and information systems, risk and data elements systems, and issues and findings systems. This information may be maintained in databases associated with the respective systems. In some cases, security data across applications related to a given risk factor may be pooled and stored with a source system having expertise directed to the risk factor. For instance, IT vulnerabilities may be handled by IT specialists, so it may be convenient to store ITSM data with an ITSM system, instead of a system specific to a given application. In other embodiments, data may be stored in multiple systems for ease of access and management.

In some systems, management of security data may be further subdivided based on expertise. Thus, in some embodiments, the ITSM system may be an application inventory information system (which may be responsible for application information data security) or a service and incident information system (which may be responsible for risks associated with loss of service and similar incidents). The application inventory data element within such systems may contain cataloguing information including application identifiers, technical specifications, deployment details, and security classifications.

In some embodiments, the GRC system may be an issue management system (which may be responsible for identifying compliance issues), a policy exceptions system (which may be responsible for evaluating deviations from a policy), a vulnerability management system (which may be responsible for evaluating the potential implications of regulatory non-compliance or non-compliance with standards), or a risk and data elements system (which may be responsible for evaluating likely impacts of vulnerabilities). Additionally, the GRC system may include a compliance system, which may be responsible for continuously monitoring adherence to regulatory requirements and organizational security policies across all managed applications.

In some embodiments, the third-party risk management (TPRM) system may be a third-party inventory and information system (which may be responsible for managing data accessible by a third-party system), a risk and data elements system (which may be responsible for evaluating potential vulnerabilities associated with a third-party system's access to information), or an issues and findings system (which may be responsible for identifying issues with third-party systems). In some embodiments, the identity management system may be an onboarded applications system (which may be responsible for a subset of applications granted authorized access to information) or a user and entitlement information system (which may be responsible for determinations surrounding user and application access to information). In some cases, security data is not divided by subject matter and pooled across applications. In such cases, the one or more source systems may be the application itself, such that the system receives security assessment data directly from one or more applications.

Security assessment system 520 may receive security assessment data from security data sources 510 and may perform security assessment calculations. This system may serve as the central processing engine that converts the security assessment data into one or more outputs. The security assessment metadata may include information such as timing, employee engagement, applicable personnel, and third-party engagement information. For example, the metadata associated with an open issue may include the length of time that the issue has been open, the employees working on the issue, the impact—if any—the issue has on internal or external users, and reliance on one or more third parties to fix the issue.

The security assessment system may implement correlation and normalization processes to analyze and process the input data. In some embodiments, the security assessment system may be configured with multiple processing modules, each dedicated to handling different aspects of data transformation. The system may utilize machine learning models to efficiently process security assessment data. In some implementations, weighted averaging may be employed to enable accurate security score calculations. The security assessment system may also incorporate historical scoring data to enhance processing accuracy and performance.

The security assessment data may be used by the system to evaluate security associated with an application based on a set of criteria, such as the prepared set of security assessment criteria. Thus, the security assessment data may be data elements associated with increased or decreased security hygiene in an application. This increased or decreased security hygiene may refer to vulnerabilities to improper or undesirable internal or external influence in the application, such as the introduction of malicious software or other hacking techniques. Increased or decreased security hygiene may also refer to evidence of undesirable outcomes in the application or inattention to the application.

Display output 530 generated by security assessment system 520 may represent evaluation results such as assessment scores, analytical insights, processed security metrics, and visualization data for decision support. This output may include normalized security assessment data elements, security assessment metadata elements, application metadata elements, tabulated scores, graphical representations of security scores, or any other desired format. The information provided in the output may be used for evaluating application security hygiene, identifying potential vulnerabilities, and prioritizing remediation efforts. In some embodiments, the output may be formatted as interactive dashboards and can be integrated with other security monitoring systems, processes, or workflows. The output may provide comprehensive visibility into application security posture and risk management quality to application owners, security teams, and organizational leadership.

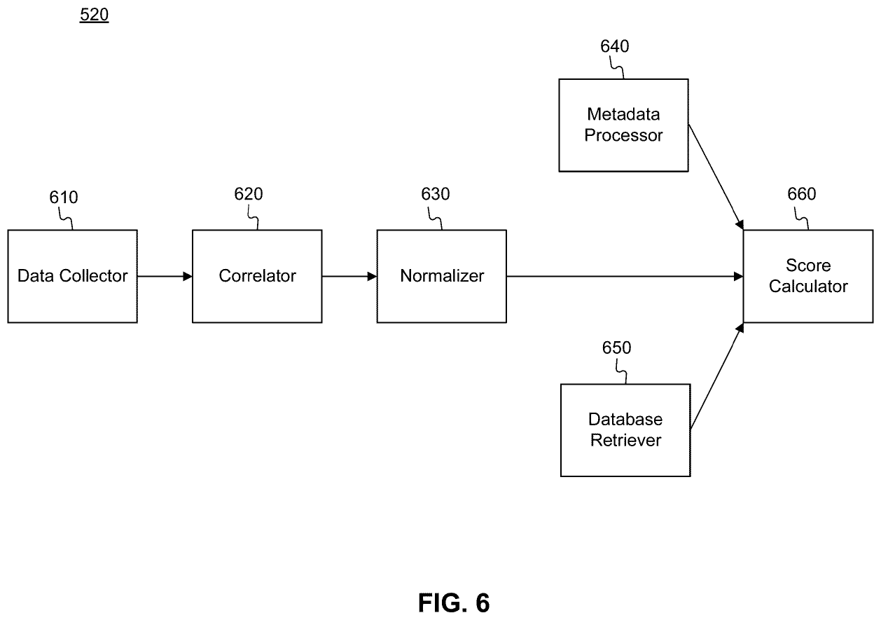

FIG. 6 is a schematic diagram showing subcomponents of the security assessment system 520 from FIG. 5, consistent with some disclosed embodiments. As shown in FIG. 6, the security assessment system may include multiple interconnected subcomponents such as data collector 610, correlator 620, normalizer 630, metadata processor 640, database retriever 650, and score calculator 660.

Data collector 610 may serve as the entry point for data from source systems 510 and may collect security assessment data elements and security assessment metadata elements.

Data collector 610 may gather security assessment data including open issues, open policy exceptions, open vulnerabilities, incidents, and third-party engagements, along with their associated metadata such as severity ratings, remediation timelines, and responsible parties. Data collector 610 may be responsible for gathering information from various source systems including ITSM systems, GRC systems, TPRM systems, and identity management systems. In some embodiments, the data collector may implement secure communication protocols to ensure confidentiality and integrity of the incoming data.

Correlator 620 may receive data from data collector 610 and may perform correlation of security assessment data elements and security assessment metadata elements with an application based on a prepared set of security assessment criteria. In embodiments in which security assessment data and security assessment metadata are received from separate sources, the security assessment data may not be initially correlated with its associated metadata. Thus, some embodiments involve correlating the plurality of security assessment data elements and the plurality of security assessment metadata elements with an application based on the prepared set of security assessment criteria. This correlating may be done based on an application code associated with the relevant application for the security assessment data and security assessment metadata. In such embodiments, the application code may be stored with the security assessment data in each source system and may be sent with the security assessment data and the security assessment metadata. Correlating may mean matching the data with the metadata based on the application code. In other embodiments, the security assessment data and security assessment metadata may be sent together and may be sent directly by the application. In such embodiments, correlating may mean keeping the security assessment data with the security assessment metadata, and not comingling the correlated data with other security assessment data or security assessment metadata associated with another application.

In some embodiments, the prepared set of security assessment criteria may be unique to the one or more source systems. The prepared set of security assessment criteria may be created exclusively for a given application, so that an evaluation of security can be tailored to the application. Alternatively, there may be a desire for security assessments to be uniform. Thus, in some embodiments, the prepared set of security assessment criteria may be identical or nearly identical across all applications for which security may be assessed. A hybrid approach may also be used, whereby a set of security assessment criteria may be used as a default or used across several applications, but criteria may be added, removed, or modified for individual applications as needed. In some embodiments, a given application may not be associated with security assessment data elements that another application is associated with. In such cases, the present system may permit null values to be supplied for one or more of the security assessment data elements or may modify the set of security assessment criteria to accommodate available data.

Data collector 610 may implement matching algorithms to associate data elements with their corresponding applications using application codes. These matching algorithms may utilize hash-based lookups where application codes serve as unique keys to create one-to-many relationships between applications and their security data. The correlation process may employ pattern matching techniques to handle variations in application code formats across different source systems, such as alphanumeric identifiers, hierarchical codes, or composite keys. In some embodiments, the algorithms may implement fuzzy matching capabilities to address minor discrepancies in application codes caused by data entry errors or system migrations. In some embodiments, correlator 620 may utilize relationship mapping frameworks to enhance processing capabilities. Data collector 610 may also incorporate error detection features to address potential mismatches or incomplete data relationships.

Normalizer 630 may receive correlated data from correlator 620 and may perform standardization of security assessment data elements to fit a set of uniform security data assessment criteria. Normalizer 630 may be responsible for reformatting variables, data elements, or fields to conform with standardized formats. In some embodiments, normalizer 630 may implement data conversion techniques to ensure consistency across varied input formats.

Normalizing may involve imposing a predefined set of criteria on the plurality of security assessment data elements and/or may involve reformatting one or more data elements of the plurality of security assessment data elements so that the plurality of security assessment data elements meets the uniform security data assessment criteria. For example, the plurality of security assessment data elements may include one or more variables, data elements, or fields that don't perfectly match variables, data elements, and fields required in the uniform security assessment criteria, but that may correspond to the variables, data elements, and fields required in the uniform security assessment criteria. In such cases, non-conforming variables, data elements, or fields may be relabelled to match the uniform security data assessment criteria. As another example, the uniform security data assessment criteria may require a given format for a given variable, such as a given number of significant figures or decimal places. In such cases, normalizing the plurality of security assessment data elements may involve adding or removing significant figures to meet such requirements. Adding or removing significant figures may impact the accuracy of data. So, normalizing may involve storing information associated with the impacted accuracy of the data.

Metadata processor 640 may handle requesting and receiving application metadata elements from the application, and it may operate as an independent component that interfaces directly with applications. Metadata processor 640 may collect various metadata categories including ITSM data elements, identity and access management data elements, and third-party management data elements, among others. The processed application metadata may provide context for security assessment calculations. This component may distinguish between metadata directly related to security and metadata that provides organizational context, such as application name, creation date, status, hosting environment, and ownership information, which may be tangentially related to security assessment but essential for proper categorization and reporting.

In some embodiments, the plurality of metadata elements includes metadata elements unrelated or only tangentially related to application security or security. Examples of application metadata elements unrelated or only tangentially related to security may include an application name, application creation date, application status, application hosting environment, application owning risk unit name, application owner, application CIO, application tech director, application tech manager, application risk unit code, application data class, a field indicating whether the application is internet-facing, an inherent risk rating, an availability variable, design documentation for the application, or a description of the application. The application metadata elements may be organized as ITSM data elements, which may include application inventory information, service information, and incident information. Each information technology service management data element may encompass specific technical and operational information categories that provide detailed context about application infrastructure, performance metrics, and support processes. An information technology service management data elements identifier may be used to uniquely reference and correlate these ITSM data elements within the broader security assessment framework, ensuring proper data relationships and traceability. The application metadata elements may be organized as identity and access management data elements, which may include onboarding status, user information, and entitlement information, which may refer to an application's access entitlement to information associated with other applications. The access management data element may include authentication credentials, authorization levels, and user access permissions that establish and control application security boundaries. The application metadata elements may be organized as third-party management data elements, which may involve third-party inventory information, risk data elements, issues, and findings. The party management data element may contain detailed information about these external relationships, including vendor contracts, service level agreements, data sharing arrangements, and specific security requirements imposed on third-party access. According to some embodiments, at least one metadata element may be selected from one or more of ITSM data elements, identity and access management data elements, and third-party management data elements. In some embodiments, at least one metadata element may be selected from ITSM data elements, identity and access management data elements, and third-party management data elements, which may facilitate the preparation of a robust scorecard associated with a given application.

In some embodiments, the metadata may be assigned or calculated based on security assessment data but may not be directly associated with a security assessment. Such metadata may be useful in grouping, organizing, or contextualizing applications. The application metadata may be configured to provide application context to application users and/or may be configured to provide context to security scorecard users. The security scorecard context may be specific to the application or may be configured to allow security scorecard users to group applications based on metadata elements. Some embodiments involve receiving the plurality of application metadata elements from the application in response to the request.

Database retriever 650 may access stored information including dashboard data, tabulated scores, and score history associated with the application, and it may function as an independent component that accesses stored historical and reference data directly from a database, such as database 350. The plurality of dashboard data may be associated with the prepared set of security assessment criteria. The dashboard data may include one or more data elements that a user assessing security may want to evaluate as part of a security assessment. Examples of dashboard data include an open issues by rating field that may track unresolved security-related problems or deficiencies identified through assessments, an open policy exceptions by rating field that may monitor approved deviations from established security policies, an open vulnerabilities by rating field that may catalogue identified security weaknesses that could be exploited, and an incidents past 12 months field that provides historical data on security breaches or events affecting system integrity. The dashboard data may further include metadata associated with the dashboard data categories.

The system may be configured to use security assessment data or application metadata to fill such fields associated with the dashboard data categories to display security data to the user. For example, dashboard data associated with open issues may include an issue ID, an issue name, an overall issue rating, an issue status, a field indicating whether the issue is a repeat issue, a target remediation data, and a field indicating the number of days remediation is past due. As another example, dashboard data associated with open policy exceptions by rating may include a policy exception identifier, a summary title, a risk rating, a policy subsection, a planned outcome, a date approved, a target remediation data, and a field indicating the number of days remediation is past due. As another example, dashboard data associated with an open vulnerabilities by rating may include an identifier, a vulnerability finding name, a severity rating, a vulnerability finding status, a vulnerability finding state, a pre-existing vulnerability field, a target remediation data, and a field indicating the number of days remediation is past due. As another example, dashboard data associated with incidents past 12 months by rating may include an incident number, a short description, a priority field, a state field, an opened filed, and a closed field.

Dashboard data may further include security elements data and identity security data. The security elements data may include fields tending to indicate risks associated with the potential dissemination of personally identifying information (PII). As such, the security elements data may include fields indicating whether PII is stored in association with an application and whether the application is public facing or may be accessed via the internet. The security elements data may further include fields indicating whether the application is hosted by a third party. Identity security data may include fields associated with application metadata showing a number of users of an application.

Dashboard data may further include fields associated with third-party applications. The dashboard data may include fields populated with application data or security data, including open security findings for third-party applications, which may include data elements such as third-party application name, relationship identifier, remediation identifier, issue title, priority, status, date created, due date, and days past due date. The dashboard data may also include additional fields to be populated with application data or security data, which may depend on metadata associated with the third-party application. Examples of such dashboard data include third-party name, relationship identifier, relationship status, a field indicating criticality of the third-party relationship, inherent risk of the third party, security-inherent risk, third-party security officer, third-party owner, description, data class, number of records, a field indicating whether the third-party application is externally facing, a field indicating whether the third party operates outside of the United States, a funds field, a security assessment result, and a security review date. The associated risk ratings may provide quantified assessments that correlate these various third-party characteristics with potential security impacts and vulnerability exposures. The dashboard data may be configured to allow the display of multiple third-party applications controlled by multiple third parties on the display.

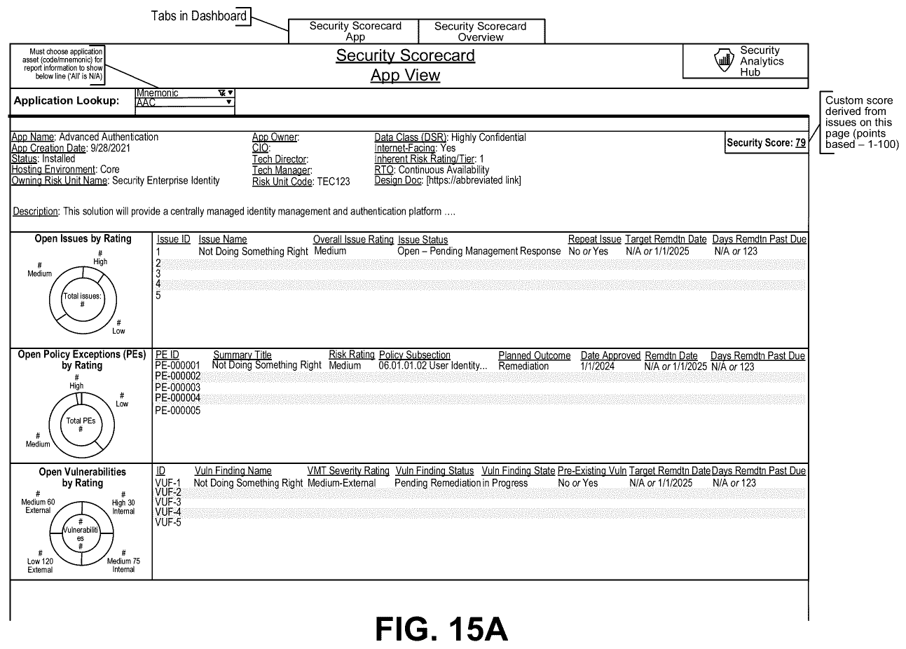

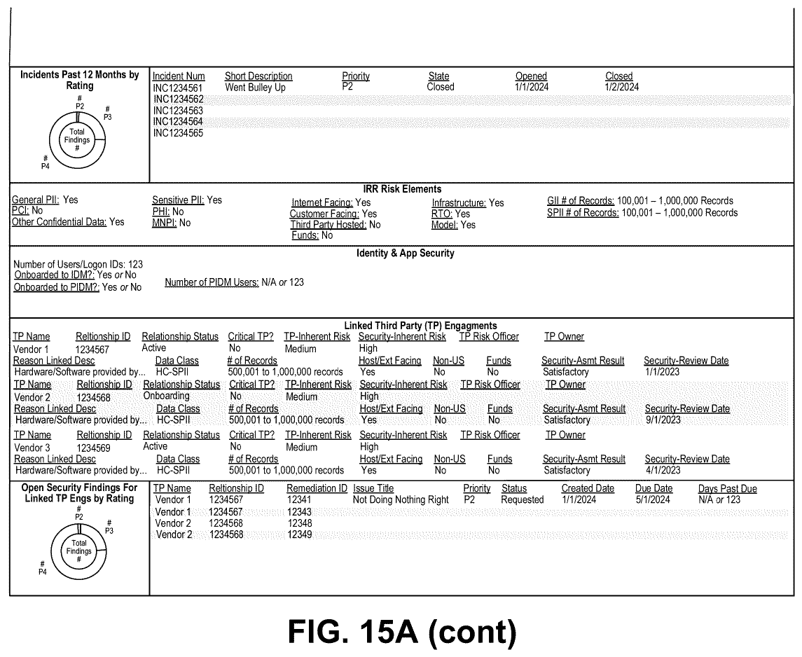

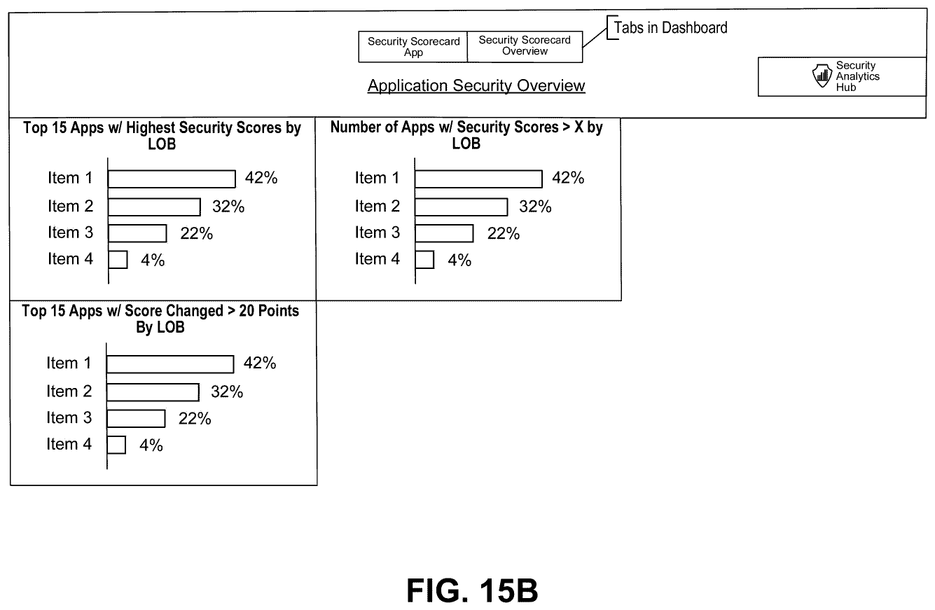

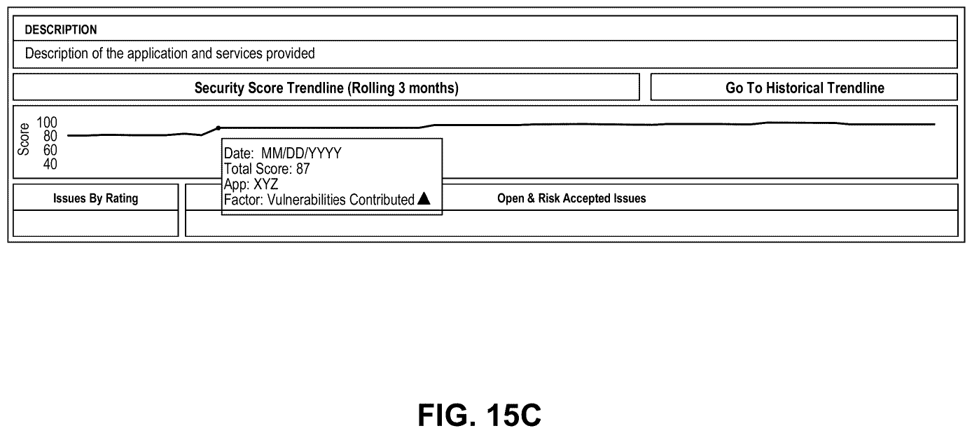

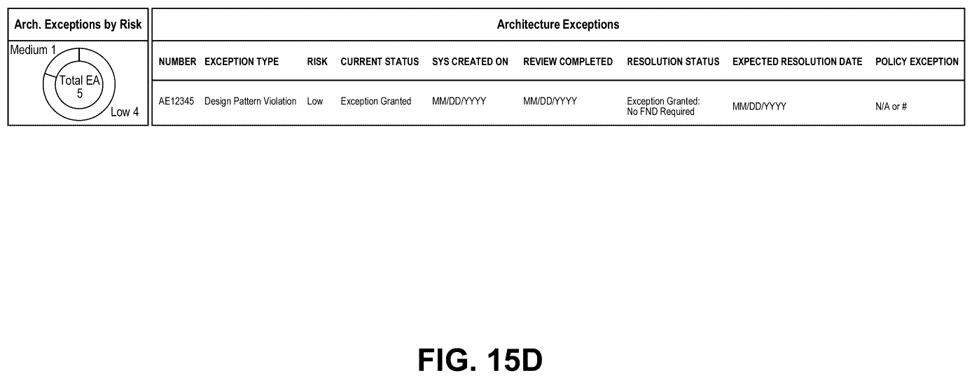

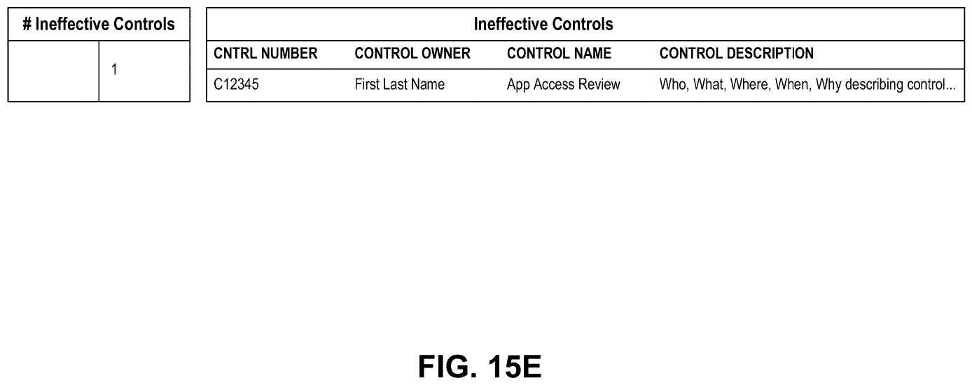

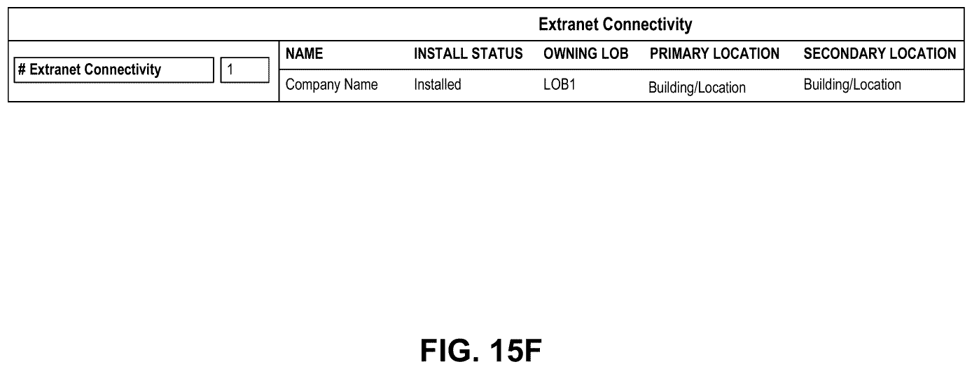

In some embodiments, the dashboard data may include application-specific data, as described above, and overview data. The overview data may include data representations summarizing security scorecard results across applications, which may include a listing of applications with the highest security scores, the number of applications with security scores above a given threshold, and applications with security scores that have changed greater than a given threshold over a given time period. The dashboard data may also include party information types, which may include detailed categorizations such as vendors, service providers, data processors, integration partners, or cloud hosting providers that have varying levels of access to application systems and data. Party issues may encompass security concerns, compliance violations, performance problems, contract disputes, or other operational challenges identified in these third-party relationships that could impact application security. Exemplary displays of exemplary dashboard data are shown in FIGS. 15A-15F.

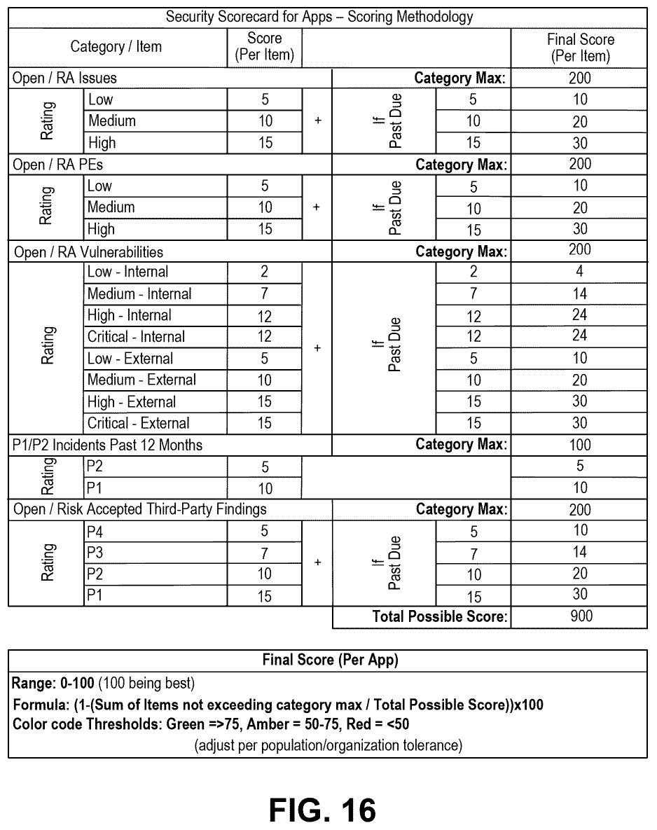

Some embodiments involve retrieving a plurality of tabulated scores from the database. The plurality of tabulated scores may be associated with the application and with the prepared set of security assessment criteria. In some embodiments, the plurality of tabulated scores may be configured to populate the dashboard data elements in a display dashboard. In some embodiments, further calculation may be necessary to convert the plurality of tabulated scores into data that a user may wish to view on a dashboard. In some embodiments, the plurality of tabulated scores may be displayed to the user in the form of a table, either before or after the performance of additional calculations. Exemplary displays of exemplary tabulated scores are shown in FIG. 16.

Some embodiments involve retrieving a score history from the database. The score history may be associated with the application. In some embodiments, the score history may include multiple scores associated with the dashboard data. The score history may include score data stored for a predetermined period of time or may include score data stored since the introduction of an application. In some embodiments, the score history may be displayed to a user on a dashboard, such as the dashboard shown in FIG. 15A. In some embodiments, the score history data may be aggregated, filtered, or modified before being displayed to the user.

Some embodiments involve, in response to the correlating and the normalizing, calculating a security assessment score from the plurality of security assessment data elements, the plurality of security assessment metadata elements, the application metadata elements, the plurality of tabulated scores, and the score history based on the prepared set of security assessment criteria. The security assessment score may be a security score showing the security hygiene or quality of risk management of an application. The security assessment score may be a single summary score and/or may be a set of security assessment scores configured to measure potential vulnerabilities across a set of criteria. The security assessment score may be associated with the dashboard data, such that the security assessment score populates fields associated with the dashboard data. The security assessment score may be calculated via weighted average of one or more security assessment data elements, one or more security assessment metadata elements, one or more application metadata elements, and one or more tabulated scores. In some embodiments, the security assessment score may be an aggregate of all available security assessment data. Calculating the security assessment score may involve assigning numerical values or weighted values to fields of the security assessment metadata elements, the application metadata elements, the plurality of tabulated scores, and the score history. For example, some fields may be filled by a binary value, such as “yes” or “no.” In such cases, 1 and 0 may be assigned to the binary value, and may be weighted based on a perceived importance of the field or the perceived impact of the field on security. The security assessment score may be a numerical value between 0 and 100, where a lower number may indicate worse security hygiene, and a higher number may indicate better security hygiene.

In some embodiments, security hygiene may refer to the potential for disclosure of sensitive data, such as PII. In such embodiments, the security assessment score may account for factors that suggest a potential for disclosure of sensitive data, such as whether sensitive data is used or stored in connection with the application; whether the application can be publicly accessed; whether sensitive information is stored or accessed by third-parties; whether the application uses encryption, anonymization, etc. ; whether storage and use of any sensitive data confirms with data privacy laws and standards; etc. In some embodiments, security hygiene may refer to potential access vulnerabilities for an application, which may include indicators that application upkeep is strong or lacking. For example, the security assessment score may account for the time necessary to remediate potential issues with the application. Bug fixes may be a form of remediating issues that may involve or be associated with fixing potential vulnerabilities. Even for bug fixes that are unrelated to potential vulnerabilities, a team's slow response rate to remediating potential issues may indicate that the application is likely to be vulnerable to attack, were bugs to exist that do impact vulnerabilities. Thus, fast response time to remediations may indicate a better security hygiene or quality of risk management for an application.

Database retriever 650 may retrieve dashboard data categories including open issues by rating, open policy exceptions by rating, open vulnerabilities by rating, and incidents from the past 12 months, etc. For each category, it may collect information such as identifiers, descriptions, ratings, statuses, remediation targets, and past-due indicators. The database retriever may also collect security elements data and identity security data, including fields related to PII storage, public accessibility, and third-party hosting. Additionally, it may retrieve historical score data spanning predefined time periods to enable trend analysis and improvement tracking. In some embodiments, database retriever 650 may implement caching mechanisms to optimize retrieval performance, such as frequently accessed dashboard configurations.

Score calculator 660 may integrate data from all previous components to calculate the security assessment score. Score calculator 660 may implement mathematical models to convert security assessment data into a quantifiable metric representing application security hygiene. The security assessment score may be calculated via weighted averaging of security assessment data elements, security assessment metadata elements, application metadata elements, and tabulated scores, among others. In some implementations, score calculator 660 may assign numerical values (e.g., between 0 and 100) to represent security hygiene, with higher (or lower) values indicating better security practices. The calculation process may account for various security factors including potential for disclosure of sensitive data, access vulnerabilities, remediation response times, and compliance with standards. In some embodiments, the score calculator may utilize machine learning models trained on applications with varying security profiles to refine the weighting criteria and improve score accuracy. Score calculator 660 may also incorporate historical score data to identify trends and calculate improvement or degradation metrics over time.

In some embodiments, the security assessment score is calculated using machine learning. In such embodiments, a machine learning model may be trained using test data describing applications of varying perceived security hygiene. The results of training the machine learning model may be refined based on the varying perceived security, such that the machine learning model's weighting criteria may be adjusted based on an administrative user's understanding of security levels across applications. Test data may include data and metadata associated with real or test applications, and may include real user data, anonymized user data, randomized data, or created test data. In some embodiments, security assessment scores may be assigned to applications associated with the test data before the test data is used to train the machine learning model, so that an administrative user can determine whether the machine learning model has appropriately calculated a security assessment score for the application.

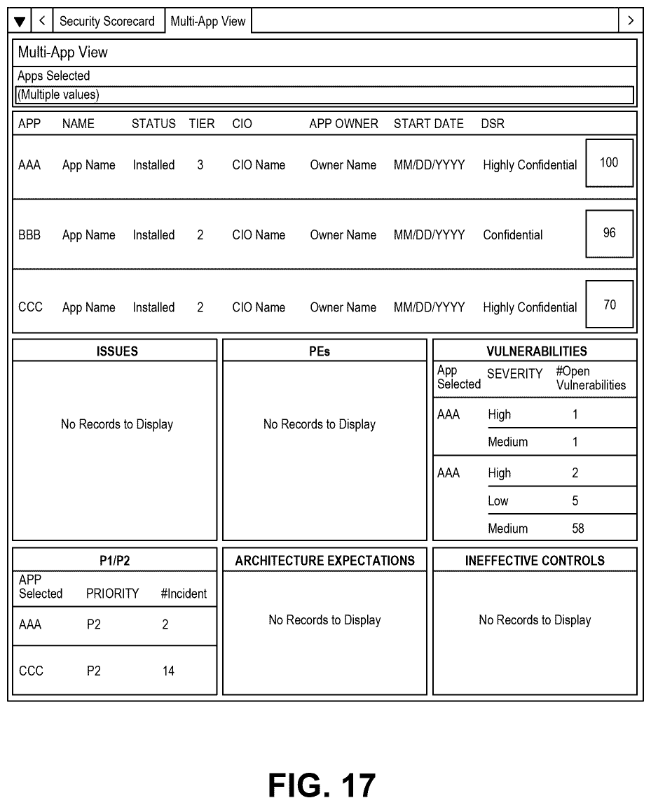

Some embodiments involve sending the security assessment score and the plurality of dashboard data over a network for display on a graphical user interface associated with a user device. The system may be configured to display this security assessment information through customizable interface elements that adapt presentation formats to user preferences and organizational reporting requirements. The security assessment score and the plurality of dashboard data may be sent over an encrypted or otherwise secure network to ensure the ongoing privacy and security of the security assessment score and plurality of dashboard data. The display on the graphical user interface may include a display of an interface such as the interface shown in FIGS. 15A-15F and/or a display of an interface such as the interface shown in FIGS. 16-17. Display of the security assessment score may include overlaying the security assessment score on a color gradient, such that the color gradient indicates whether the security assessment score is associated with a better or worse security hygiene. For example, a display of a worse security score may place the score on a red portion of a color gradient, while a display of a better security score may place the score on a green portion of a color gradient.

The display may further include graphical display of data associated with the security assessment score, as shown in exemplary displays in FIGS. 15A-15F and FIGS. 16-17. For example, the display may present factors associated with a worse or better security score, such as the number of open issues, open policy exceptions, open vulnerabilities, and/or incidents in the past 12 months. Each of these values may be color coded to aid display and interpretation of the data. The display of this data may help demonstrate to a user why a given application received a given security assessment score. The display may further include security assessment information across multiple applications, as described above, and may include the graphical display of historical data and/or historical security scores. The display may further include an example formula for calculating the security assessment score and an explanation interpreting one or more elements of the security assessment score.

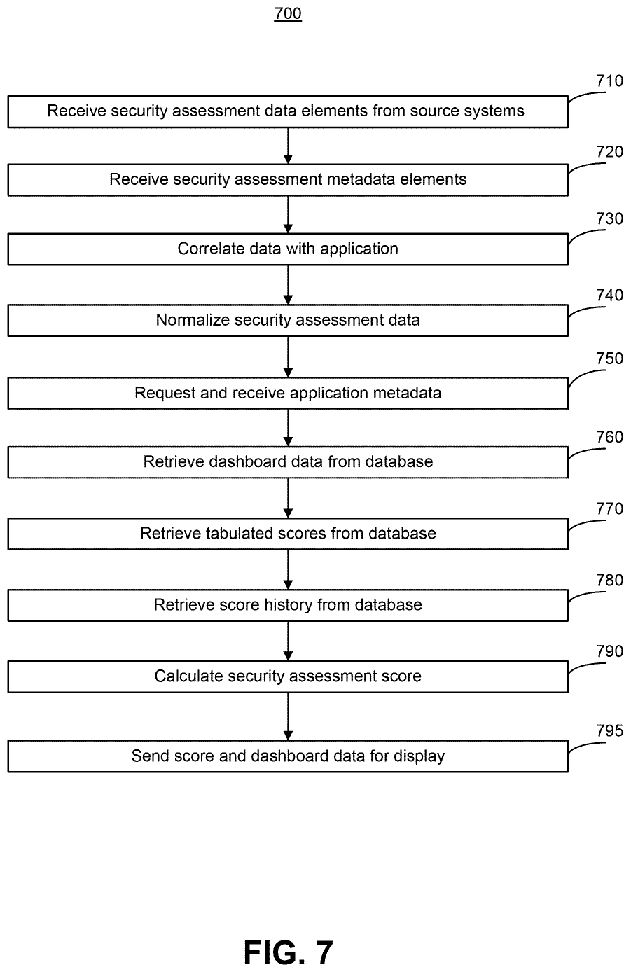

FIG. 7 is a flow chart of example operations that may be taken by the application security assessment system described herein, consistent with some disclosed embodiments. At step 710, security assessment data elements may be received from one or more source systems. This step may involve establishing secure connections with various data sources and retrieving security-related information based on a prepared set of security assessment criteria. The source systems may include information technology service management systems, governance, risk, and compliance systems, third-party risk management systems, and identity management systems, among others. For example, the system may retrieve open issues, open policy exceptions, open vulnerabilities, incidents, and third-party engagement information using API requests or data transfer protocols. In some embodiments, customized data extraction techniques may be utilized to accommodate varying data formats across different source systems. According to some exemplary embodiments, automated scheduling capabilities may be employed to enhance data freshness by retrieving security assessment data at predetermined intervals. This process may help ensure comprehensive collection of security-relevant information which facilitates accurate security assessment and score calculation.

At step 720, security assessment metadata elements correlated with the security assessment data elements may be collected from the one or more source systems. Once step 710 is completed, step 720 may process the initial security data to retrieve associated metadata providing additional context and relationship information. In some embodiments, step 720 may involve parsing response headers, accessing linked resources, or making secondary requests to efficiently handle metadata retrieval operations. The process may implement correlation identifiers to ensure proper association between data elements and their corresponding metadata. For instance, timestamp information, employee engagement details, applicable personnel records, and third-party engagement status may be used to provide contextual information for security assessment data. In other embodiments, however, batch retrieval of metadata may be employed to reduce network overhead and improve performance. According to some exemplary embodiments, metadata collection may also incorporate validation checks that enhance data quality by identifying inconsistencies or missing associations between security assessment data and metadata elements.

At step 730, the security assessment data elements and security assessment metadata elements may be correlated with an application. This step may involve analyzing the application code associated with the security assessment data and metadata to establish proper relationships, which may involve linking each piece of security data and metadata to its corresponding application. In some embodiments, step 730 may implement matching algorithms to identify and link data elements belonging to the same application. The correlation process may prevent commingling of data between applications by maintaining strict boundaries based on application identifiers. For example, application codes stored within security assessment data may be used to group related information together for subsequent processing. According to some exemplary embodiments, correlation operations may also include error detection routines that flag potential mismatches or orphaned data elements.

At step 740, the security assessment data elements may be normalized to fit a set of uniform security data assessment criteria. This step may involve converting data from various formats into a standardized structure that enables consistent evaluation. In some embodiments, step 740 may apply predefined rules to reformat variables, relabel fields, and adjust numerical precision to meet uniform requirements. The normalization process may handle cases where input data contains null values or incomplete information. For example, decimal standardization, unit conversion, and terminology mapping may be performed to ensure data consistency. According to some exemplary embodiments, normalization may also track data provenance information that maintains a record of conversions applied to preserve analytical integrity.

At step 750, application metadata elements may be requested and received from the application. This step may involve communicating directly with the application to obtain context-specific information that may not be available from the source systems. In some embodiments, step 750 may utilize application programming interfaces or structured queries to efficiently gather metadata including application name, creation date, status, hosting environment, and ownership information. The process may implement secure authentication mechanisms to ensure proper access to application resources. For example, application metadata categories such as ITSM data elements, identity and access management data elements, and third-party management data elements may be collected to provide comprehensive context. According to some exemplary embodiments, adaptive request scheduling may be employed to minimize performance impact on the target application during metadata collection.

At step 760, dashboard data may be retrieved from a database. This step may involve accessing stored display configurations, visualization parameters, and presentation templates that will eventually render the security assessment information. In some embodiments, step 760 may query structured storage systems to efficiently retrieve dashboard elements including display categories for open issues, policy exceptions, vulnerabilities, and incidents. The retrieval process may incorporate permission controls to ensure appropriate data access. For example, dashboard data categories with associated fields for identifiers, descriptions, ratings, and remediation targets may be loaded into memory for subsequent processing. According to some exemplary embodiments, intelligent caching mechanisms may be employed to enhance retrieval performance for frequently accessed dashboard configurations. Intelligent caching mechanisms may involve storing frequently accessed dashboard configurations in high-speed memory (such as RAM or SSD cache) to reduce database query latency. It may involve, for example, invalidation policies, least-recently-used (LRU) algorithms, and/or predictive pre-loading based on user access patterns.

At step 770, tabulated scores may be retrieved from the database. This step may involve accessing previously calculated or baseline metrics that provide comparative context for the current security assessment. In some embodiments, step 770 may implement database operations to efficiently collect score tables associated with the application and with the prepared set of security assessment criteria. The retrieval process may include data validation to ensure score integrity. For example, structured query language or object-relational mapping techniques may be used to access stored tabulated scores from persistent storage. According to some exemplary embodiments, version control mechanisms may be employed to track changes in scoring methodologies over time, ensuring proper historical comparisons.

At step 780, score history may be retrieved from the database. This step may involve accessing historical security assessment results to enable trend analysis and performance tracking. In some embodiments, step 780 may utilize time-series data stores to efficiently retrieve chronological score information associated with the application. The retrieval process may implement filtering based on time periods or assessment versions. For example, historical scores spanning predetermined time windows may be collected to establish security performance baselines and identify improvement or degradation patterns. According to some exemplary embodiments, aggregation functions may be employed to derive statistical insights from raw historical data, enhancing the analytical value of the retrieved information.

At step 790, a security assessment score may be calculated. This step may involve processing all previously collected data through mathematical models or algorithms to produce a quantifiable measure of security hygiene. In some embodiments, step 790 may apply weighted averaging techniques or machine learning models to convert diverse security indicators into a single comprehensive score. The calculation process may incorporate variable weighting based on risk significance. For example, security elements related to Personally Identifiable Information (PII) protection, access vulnerabilities, and remediation responsiveness may be evaluated and combined into a numerical value between 0 and 100, with higher values indicating better security practices. According to some exemplary embodiments, sensitivity analysis may be employed to validate calculation stability and identify factors with the greatest influence on the final score.

At step 795, the security assessment score and dashboard data may be sent over a network to a user device for display. This step may involve transmitting the processed results to a user device where they can be visualized and interpreted. In some embodiments, step 795 may implement secure communication protocols to efficiently deliver assessment information while maintaining data protection. The transmission process may include formatting optimizations to accommodate various display devices. For example, the security assessment score may be overlaid on a color gradient where red indicates poor security hygiene and green indicates strong security practices, alongside graphical representations of contributing factors. According to some exemplary embodiments, interactive elements may be included in the transmitted data to enable user exploration of specific security aspects, enhancing the utility and actionability of the assessment results.

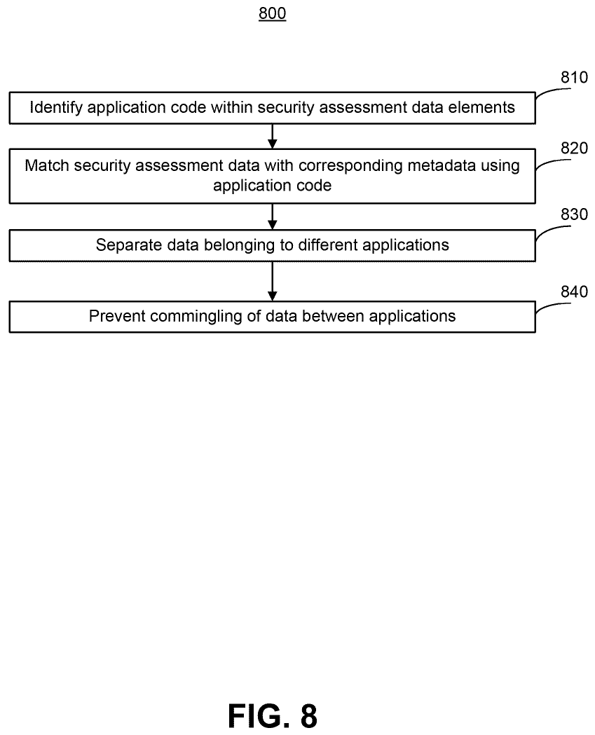

FIG. 8 is a flow chart of example data collection and correlation operations, consistent with some disclosed embodiments. In some embodiments, the steps of FIG. 8 may be performed by correlator 620 from the security assessment system.

At step 810, application codes within security assessment data elements may be identified. This step may involve examining the security assessment data elements received from source systems to locate application identifiers that establish relationships between data and specific applications. The application code may be stored with the security assessment data in each source system and may be transmitted along with the security assessment data and security assessment metadata. For example, the system may parse incoming data structures to extract application identifiers using field recognition algorithms or predefined data schemas. In some embodiments, multiple identification methods may be utilized to accommodate varying data formats across different source systems. According to some exemplary embodiments, validation routines may be employed to enhance accuracy by confirming that identified application codes conform to expected identifier formats. This process may help ensure proper data attribution which may facilitate accurate correlation between security assessment data and their corresponding applications.

At step 820, security assessment data may be matched with corresponding metadata from the one or more source systems using the identified application codes. Once step 810 is completed, step 820 may process the identified application codes to perform correlation operations that link security assessment data elements with their associated metadata elements. In some embodiments, step 820 may involve matching algorithms that use application codes as primary keys to establish data relationships. The process may implement correlation techniques based on the prepared set of security assessment criteria to ensure proper association. For instance, database join operations or hash table lookups may be used to match security assessment data with metadata elements that share identical application codes. In other embodiments, however, relationship mapping frameworks may be employed to handle more complex correlation scenarios involving multiple identifier types. According to some exemplary embodiments, correlation matching may also incorporate error detection capabilities to potentially enhance data quality by identifying potential relationship inconsistencies.

At step 830, data belonging to different applications may be separated. This step may involve organizing the matched security assessment data and metadata elements into distinct groups based on their associated application codes. In some embodiments, step 830 may implement partitioning algorithms to efficiently categorize data elements according to their application relationships. The separation process may maintain boundaries to ensure that each application's security assessment information remains isolated from other applications' data. For example, data structures such as hash maps or indexed collections may be used to group related information while maintaining clear application boundaries. According to some exemplary embodiments, separation operations may also include verification checks that ensure complete data segregation across application boundaries.

At step 840, commingling of data between applications may be prevented. This step may involve implementing safeguards and validation mechanisms to maintain data integrity across application boundaries throughout the correlation process. In some embodiments, step 840 may utilize access control patterns and data encapsulation techniques to efficiently prevent inadvertent data mixing between different applications. The process may implement boundary enforcement algorithms to ensure that security assessment data and metadata remain properly associated with their correct applications. For instance, container-based data management or namespace isolation techniques may be used to maintain strict separation between applications' security assessment information. According to some exemplary embodiments, prevention mechanisms may also incorporate audit trails that enhance data governance by tracking correlation operations and maintaining records of data handling procedures.

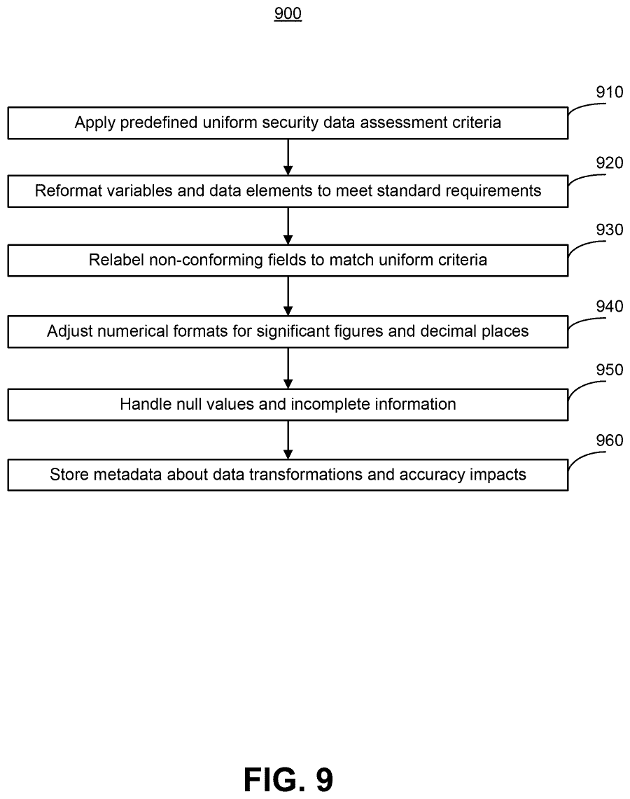

FIG. 9 is a flow chart of example data normalization operations, consistent with some disclosed embodiments. In some embodiments, the steps of FIG. 9 may be performed by normalizer 630 from the security assessment system.

At step 910, predefined uniform security data assessment criteria may be applied to the correlated security assessment data elements. This step may involve imposing a standardized set of criteria on the plurality of security assessment data elements to ensure consistency across different data sources and applications. The uniform security data assessment criteria may define the required structure, format, and content specifications that all security assessment data must conform to before further processing. For example, the system may reference a configuration file or rule set that specifies required data fields, acceptable value ranges, and formatting standards using predefined schema validation techniques. In some embodiments, adaptive criteria application may be utilized to accommodate variations in available data across different applications. According to some exemplary embodiments, criteria validation routines may be employed to enhance data quality by verifying that incoming data elements can be successfully normalized according to the uniform requirements. This process may help ensure standardized data structure which facilitates consistent security assessment calculations across all applications.

At step 920, variables and data elements may be reformatted to meet standard requirements. Once step 910 is completed, step 920 may process the security assessment data elements to perform structural transformations that align with the uniform security data assessment criteria. In some embodiments, step 920 may involve data transformation algorithms that convert diverse input formats into standardized representations. The process may implement formatting rules to ensure compliance with predefined data specifications. For instance, date standardization, text case normalization, or data type conversion operations may be used to transform incoming data elements into consistent formats. In other embodiments, however, template-based reformatting may be employed to handle complex data structure transformations more efficiently. According to some exemplary embodiments, reformatting operations may also incorporate validation checks that enhance accuracy by confirming successful data transformation.

At step 930, non-conforming fields may be relabeled to match uniform criteria. This step may involve identifying data elements that correspond to required uniform criteria but use different naming conventions or field identifiers. In some embodiments, step 930 may implement mapping algorithms to efficiently translate field names and identifiers according to standardized terminology. The relabeling process may utilize lookup tables or translation dictionaries to ensure proper field identification. For example, field mapping operations using synonym tables or ontology-based translation may be used to convert source system field names into standardized labels required by the uniform criteria. According to some exemplary embodiments, relabeling operations may also include confidence scoring mechanisms that enhance reliability by tracking the accuracy of field name translations.

At step 940, numerical formats may be adjusted for significant figures and decimal places. This step may involve modifying numerical data elements to conform to specific precision and formatting requirements defined in the uniform security data assessment criteria. In some embodiments, step 940 may utilize mathematical rounding and formatting functions to efficiently standardize numerical representations across all data elements. The adjustment process may implement precision control algorithms to ensure consistent numerical formatting. For instance, decimal truncation, rounding operations, or scientific notation conversion may be used to achieve the required number of significant figures or decimal places. According to some exemplary embodiments, format adjustment operations may also include precision tracking capabilities that enhance data quality by documenting changes made to original numerical values.

At step 950, null values and incomplete information may be handled according to system requirements. This step may involve implementing strategies to address missing or unavailable security assessment data elements that some applications may not be associated with. In some embodiments, step 950 may utilize null value substitution techniques or criteria modification approaches to efficiently accommodate data gaps. The handling process may implement decision logic to determine appropriate responses to missing data based on the security assessment context. For example, default value assignment, data interpolation, or criteria adjustment operations may be used to address situations where applications lack certain security assessment data elements. According to some exemplary embodiments, incomplete data handling may also incorporate impact assessment capabilities that enhance transparency by documenting the effects of missing information on security assessment accuracy.

At step 960, metadata about data transformations and accuracy impacts may be stored in the database for future reference. This step may involve creating detailed records of all normalization operations performed on the security assessment data elements to maintain data provenance and quality tracking. In some embodiments, step 960 may implement audit logging systems to efficiently capture transformation details and accuracy implications. The storage process may maintain comprehensive records of normalization activities for quality assurance and traceability purposes. For instance, transformation logs, accuracy impact assessments, or data lineage records may be used to document how original data elements were modified during the normalization process. According to some exemplary embodiments, metadata storage operations may also incorporate version control mechanisms that enhance data governance by maintaining historical records of normalization procedures and their effects on data accuracy.

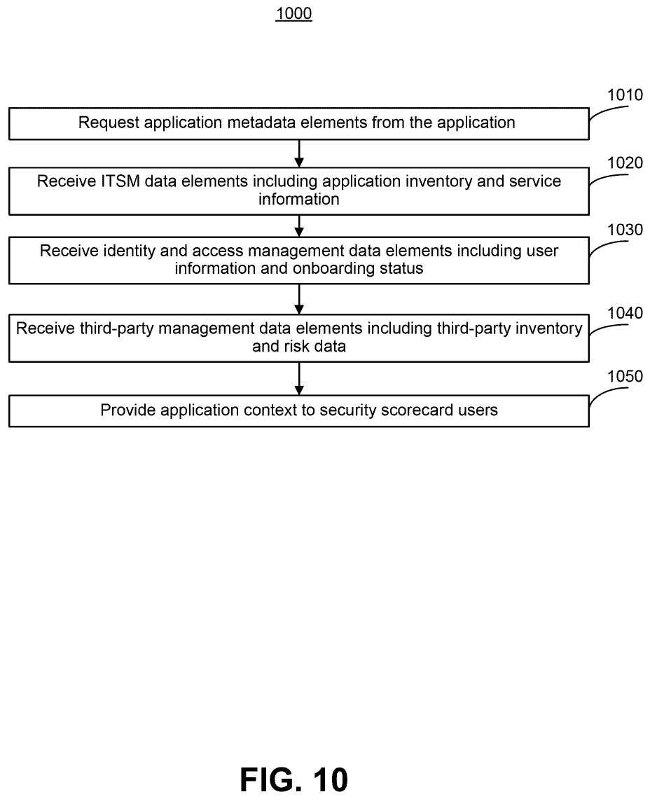

FIG. 10 is a flow chart of example application metadata processing operations, consistent with some disclosed embodiments. In some embodiments, the steps of FIG. 10 may be performed by metadata processor 640 from the security assessment system.

At step 1010, application metadata elements may be requested from the application. This step may involve initiating communication with the target application to obtain context-specific information that provides organizational and operational details beyond what is available from external source systems. The application metadata elements may include metadata elements unrelated or only tangentially related to application security, such as application name, creation date, status, hosting environment, and ownership information. For example, the system may utilize application programming interfaces, structured queries, or direct application communication protocols to request comprehensive metadata from the application. In some embodiments, secure authentication mechanisms may be utilized to ensure proper access authorization when requesting sensitive application information. According to some exemplary embodiments, adaptive request scheduling may be employed to enhance performance by minimizing impact on the target application during metadata collection. This process may help ensure comprehensive application context to facilitate accurate security assessment and meaningful scorecard interpretation.

At step 1020, ITSM data elements including application inventory and service information may be received from the application. Once step 1010 is completed, step 1020 may process the application's response to collect information technology service management data that provides operational context for security assessment. In some embodiments, step 1020 may involve structured data reception techniques that efficiently capture application inventory information, service information, and incident information from the target application. The process may implement data validation algorithms to ensure completeness and accuracy of received ITSM data. For instance, application inventory details, service management records, or operational incident history may be used to establish the application's operational characteristics and maintenance patterns. In other embodiments, however, batch data collection approaches may be employed to optimize network efficiency when retrieving comprehensive ITSM information. According to some exemplary embodiments, ITSM data reception may also incorporate error handling capabilities that enhance reliability by managing incomplete or corrupted data transmissions.

At step 1030, identity and access management data elements including user information and onboarding status may be received from the application. This step may involve collecting authentication and authorization information that provides insight into the application's user base and security integration status. In some embodiments, step 1030 may implement identity data processing techniques to efficiently capture onboarding status, user information, and entitlement information from the application. The reception process may utilize secure data handling protocols to protect sensitive identity information during transmission. For example, user count data, access entitlement records, or application onboarding status information may be used to understand the application's integration with organizational security systems. According to some exemplary embodiments, identity data reception may also include privacy protection mechanisms that enhance security by ensuring appropriate handling of user-related information during the metadata collection process.

At step 1040, third-party management data elements including third-party inventory and risk data may be received from the application. This step may involve collecting information about external relationships and dependencies that may impact the application's security posture. In some embodiments, step 1040 may utilize third-party data integration techniques to efficiently capture third-party inventory information, risk data elements, issues, and findings associated with the application. The reception process may implement relationship mapping algorithms to properly associate third-party information with security assessment context. For example, third-party engagement details, external service dependencies, or vendor risk assessments may be used to evaluate the application's exposure to third-party security risks. According to some exemplary embodiments, third-party data reception may also incorporate risk classification capabilities that enhance assessment accuracy by categorizing third-party relationships based on their potential security impact.

At step 1050, application context may be provided to security scorecard users. This step may involve formatting and organizing the collected application metadata elements to facilitate meaningful interpretation of security assessment results by end users. In some embodiments, step 1050 may implement context presentation techniques that efficiently organize application metadata to support both application users and security scorecard users in understanding assessment results. The context provision process may utilize information categorization algorithms to present metadata in formats that enhance scorecard usability. For example, application classification details, organizational context, or operational characteristics may be used to help users understand the specific circumstances and environment that influence the application's security assessment score. According to some exemplary embodiments, context provision may also incorporate interactive presentation capabilities that enhance user experience by allowing security scorecard users to explore application metadata elements and understand how they contribute to security assessment interpretation.

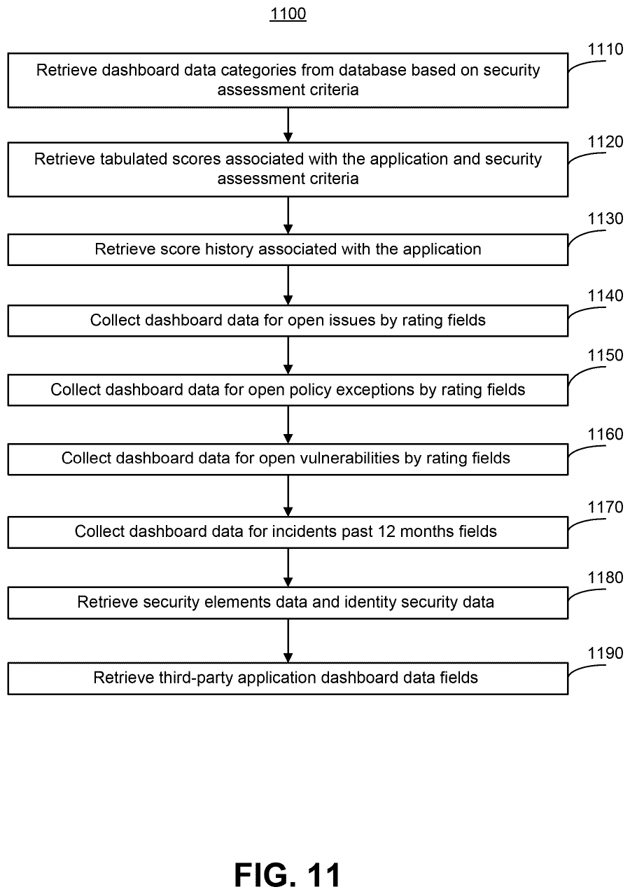

FIG. 11 is a flow chart of example database retrieval operations, consistent with some disclosed embodiments. In some embodiments, the steps of FIG. 11 may be performed by database retriever 650 from the security assessment system.

At step 1110, dashboard data categories may be retrieved from the database based on security assessment criteria. This step may involve accessing stored display configurations and presentation templates that are associated with the prepared set of security assessment criteria. The dashboard data may include one or more data elements that a user assessing security may want to evaluate as part of a security assessment. For example, the system may execute database queries or object-relational mapping operations to retrieve dashboard data categories using structured query language or NoSQL database access methods. In some embodiments, permission-based access controls may be utilized to ensure appropriate data access during dashboard data retrieval operations. According to some exemplary embodiments, intelligent caching mechanisms may be employed to enhance retrieval performance for frequently accessed dashboard configurations, as explained above in connection with step 760 of FIG. 7. This process may help ensure comprehensive dashboard foundation which facilitates effective security assessment data presentation.

At step 1120, tabulated scores associated with the application and security assessment criteria may be retrieved from the database. This step may involve accessing previously calculated or baseline metrics that provide comparative context for the current security assessment. In some embodiments, step 1120 may implement database operations to efficiently collect score tables that are configured to populate the dashboard data elements in a display dashboard. The retrieval process may include data validation techniques to ensure score integrity and accuracy. For example, relational database joins, indexed lookups, or time-series data queries may be used to access stored tabulated scores from persistent storage systems. According to some exemplary embodiments, version control mechanisms may be employed to enhance data governance by tracking changes in scoring methodologies over time and ensuring proper historical comparisons.

At step 1130, score history associated with the application may be retrieved from the database. This step may involve accessing historical security assessment results to enable trend analysis and performance tracking over time. In some embodiments, step 1130 may utilize time-series data stores to efficiently retrieve chronological score information that includes multiple scores associated with the dashboard data. The retrieval process may implement filtering capabilities based on predetermined time periods or assessment versions. For example, temporal database queries, historical data archiving systems, or chronological indexing methods may be used to collect score data stored since the introduction of an application. According to some exemplary embodiments, aggregation functions may be employed to enhance analytical value by deriving statistical insights from raw historical data before presentation.

At step 1140, dashboard data for open issues by rating fields may be collected from the database. This step may involve retrieving specific data elements associated with security issues that require attention and remediation. In some embodiments, step 1140 may implement targeted data collection techniques to efficiently gather issue-specific information including identifiers, descriptions, ratings, and remediation status. The collection process may utilize structured data formats to organize issue information for dashboard presentation. For example, issue ID, issue name, overall issue rating, issue status, repeat issue indicators, target remediation dates, and days past due calculations may be used to populate dashboard fields related to open security issues. According to some exemplary embodiments, priority-based sorting capabilities may be employed to enhance usability by organizing issue data according to severity or urgency levels.

At step 1150, dashboard data for open policy exceptions by rating fields may be collected from the database. This step may involve retrieving information about approved deviations from security policies that require monitoring and eventual remediation. In some embodiments, step 1150 may utilize policy management data integration techniques to efficiently capture exception details including identifiers, summaries, risk assessments, and planned outcomes. The collection process may implement compliance tracking algorithms to monitor exception status and remediation progress. For example, policy exception identifier, summary title, risk rating, policy subsection, planned outcome, date approved, target remediation date, and days past due information may be used to populate dashboard sections dedicated to policy exception management. According to some exemplary embodiments, risk categorization mechanisms may be employed to enhance visibility by grouping policy exceptions according to their potential security impact.

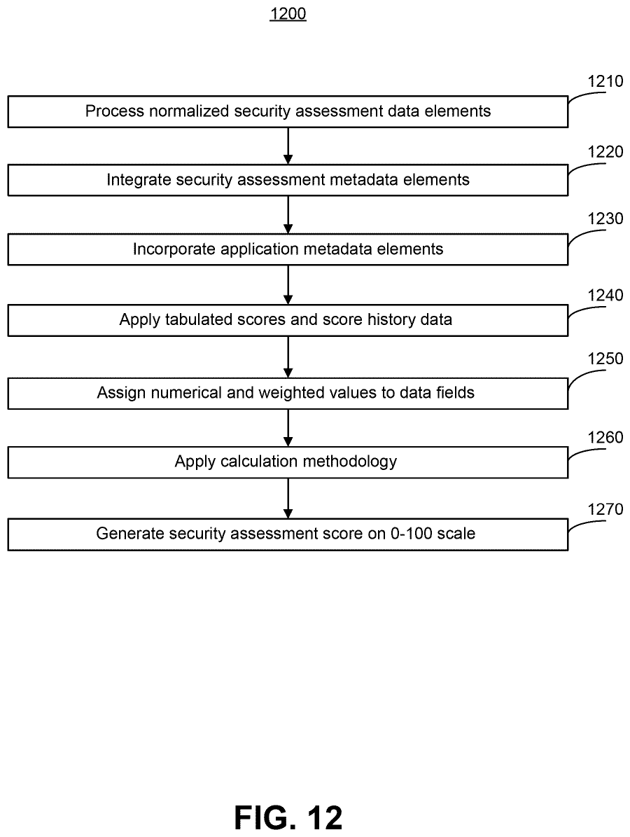

At step 1160, dashboard data for open vulnerabilities by rating fields may be collected from the database. This step may involve retrieving detailed information about identified security vulnerabilities that require assessment and remediation. In some embodiments, step 1160 may implement vulnerability management data processing techniques to efficiently gather vulnerability details including findings, severity ratings, and remediation status. The collection process may utilize threat assessment frameworks to properly categorize vulnerability information. For example, vulnerability identifier, finding name, severity rating, finding status, finding state, pre-existing vulnerability indicators, target remediation date, and days past due calculations may be used to populate dashboard components focused on vulnerability management. According to some exemplary embodiments, severity-based prioritization may be employed (as explained in further detail in connection with FIG. 12) to enhance decision-making by highlighting the most critical vulnerabilities requiring immediate attention.

At step 1170, dashboard data for incidents past 12 months fields may be collected from the database. This step may involve retrieving historical incident information to provide context about the application's operational stability and security event frequency. In some embodiments, step 1170 may utilize incident management system integration techniques to efficiently capture incident details including descriptions, priorities, and resolution status. The collection process may implement temporal filtering algorithms to focus on relevant time periods for incident analysis. For example, incident number, short description, priority field, state field, opened date, and closed date information may be used to populate dashboard areas dedicated to incident tracking and analysis. According to some exemplary embodiments, trend analysis capabilities may be employed to enhance insight by identifying patterns in incident frequency and resolution times.

At step 1180, security elements data and identity security data may be retrieved from the database. This step may involve collecting specialized data elements that indicate risks associated with personally identifying information and user access patterns. In some embodiments, step 1180 may implement privacy-focused data collection techniques to efficiently gather information about PII storage, public accessibility, and third-party hosting arrangements. The retrieval process may utilize data classification frameworks to properly categorize security-sensitive information. For example, fields indicating PII storage status, internet accessibility, third-party hosting arrangements, and user count information may be used to assess the application's exposure to data privacy and access security risks. According to some exemplary embodiments, privacy protection mechanisms may be employed to enhance security by ensuring appropriate handling of sensitive identity and access information during retrieval operations.

At step 1190, third-party application dashboard data fields may be retrieved from the database. This step may involve collecting comprehensive information about external applications and vendor relationships that may impact the application's security posture. In some embodiments, step 1190 may utilize third-party management system integration techniques to efficiently capture vendor details, relationship status, and associated security findings. The retrieval process may implement relationship mapping algorithms to properly associate third-party information with security assessment context. For example, third-party application name, relationship identifier, remediation identifier, issue title, priority, status, date created, due date, days past due, third-party name, relationship status, criticality indicators, inherent risk assessments, and security review information may be used to populate dashboard sections dedicated to third-party risk management. According to some exemplary embodiments, multi-vendor display capabilities may be employed to enhance oversight by allowing simultaneous monitoring of multiple third-party applications controlled by different vendors on the same dashboard interface.

FIG. 12 is a flow chart of example security score calculation operations, consistent with some disclosed embodiments. In some embodiments, the steps of FIG. 12 may be performed by score calculator 660 from the security assessment system.

At step 1210, normalized security assessment data elements may be processed for score calculation. This step may involve receiving and organizing the standardized security assessment data elements that have undergone correlation and normalization procedures from previous system components. The normalized security assessment data elements may include open issues, open policy exceptions, open vulnerabilities, incidents, and third-party engagements that have been formatted according to uniform security data assessment criteria. For example, the system may load normalized data structures containing security assessment information using data processing frameworks or in-memory computation techniques. In some embodiments, parallel processing approaches may be utilized to efficiently handle large volumes of normalized security data. According to some exemplary embodiments, data validation routines may be employed to enhance reliability by confirming that processed data elements meet quality standards for score calculation. This process may help ensure accurate data foundation to facilitate reliable security assessment score computation.

At step 1220, security assessment metadata elements may be integrated with the normalized data. This step may involve combining contextual information with the normalized security data to provide comprehensive input for score calculation. The security assessment metadata may include information such as timing, employee engagement, applicable personnel, and third-party engagement information. For example, metadata associated with an open issue may include the length of time that the issue has been open, the employees working on the issue, the impact the issue has on internal or external users, and reliance on third parties to fix the issue. In some embodiments, metadata correlation algorithms may be utilized to efficiently merge timing information, employee engagement details, and impact assessments with their corresponding security assessment data elements. According to some exemplary embodiments, completeness checks may be employed to enhance data quality by identifying missing contextual information that could affect score accuracy.

At step 1230, application metadata elements may be incorporated into the calculation framework. This step may involve integrating application-specific contextual information that provides organizational and operational context for the security assessment. The application metadata elements may include ITSM data elements, identity and access management data elements, and third-party management data elements. For example, application metadata including application name, creation date, hosting environment, ownership information, and risk classification may be used to provide contextual factors that influence security score calculation. In some embodiments, metadata fusion algorithms may be utilized to combine different categories of application metadata with the security assessment information. According to some exemplary embodiments, relevance scoring mechanisms may be employed to enhance accuracy by determining the significance of different metadata elements for specific applications.

At step 1240, tabulated scores and score history data retrieved from the database may be applied to the calculation process. This step may involve integrating previously calculated metrics and historical performance data to provide comparative context and trend analysis for the current security assessment. The tabulated scores may be associated with the application and with the prepared set of security assessment criteria, while the score history may include multiple scores associated with the dashboard data stored for a predetermined period of time. For example, trend analysis, baseline comparison, or performance tracking operations may be used to incorporate tabulated scores and historical security assessment data into the current score calculation. In some embodiments, historical data processing techniques may be utilized to efficiently incorporate baseline scores and performance trends into the current calculation framework. According to some exemplary embodiments, statistical analysis capabilities may be employed to enhance insight by identifying patterns and trends in security performance over time.

At step 1250, numerical and weighted values may be assigned to data fields based on their security significance. This step may involve converting qualitative security assessment information into quantitative metrics that can be mathematically processed for score calculation. The assignment process may involve assigning numerical values or weighted values to fields of the security assessment metadata elements, the application metadata elements, the plurality of tabulated scores, and the score history. For example, binary field conversion where “yes” and “no” values are assigned 1 and 0, risk factor weighting, or impact severity scoring may be used to assign numerical values where higher weights may be given to factors suggesting greater security risk such as PII exposure or slow remediation response times. In some embodiments, value assignment algorithms may be utilized to efficiently convert binary values, categorical data, and descriptive information into numerical representations. According to some exemplary embodiments, sensitivity analysis capabilities may be employed to enhance calibration by testing the impact of different weighting approaches on final score calculations.

At step 1260, calculation methodology may be applied. This step may involve executing mathematical algorithms that convert the weighted numerical values into a comprehensive security assessment score. The security assessment score may be calculated via weighted average of one or more security assessment data elements, one or more security assessment metadata elements, one or more application metadata elements, and one or more tabulated scores. For example, linear weighted combination, polynomial regression, or trained neural network models may be used to calculate security assessment scores based on the prepared set of security assessment criteria. In some embodiments, machine learning models may be utilized where a machine learning model is trained using test data describing applications of varying perceived security hygiene. According to some exemplary embodiments, ensemble methods combining multiple calculation approaches may be employed to improve score accuracy and reliability.

At step 1270, the security assessment score may be generated on a 0-100 scale representing application security hygiene. This step may involve scaling and formatting the calculated security metrics into a standardized numerical representation that indicates security quality. The security assessment score may be a numerical value between 0 and 100, where a lower number may indicate worse security hygiene, and a higher number may indicate better security hygiene. For example, linear scaling, percentile mapping, or threshold-based categorization may be used to produce final security assessment scores where the score represents the security hygiene or quality of risk management of an application. In some embodiments, score normalization algorithms may be utilized to efficiently convert raw calculation results into the standardized 0-100 range. According to some exemplary embodiments, confidence intervals may be employed to enhance transparency by indicating the reliability and precision of the calculated security assessment score.

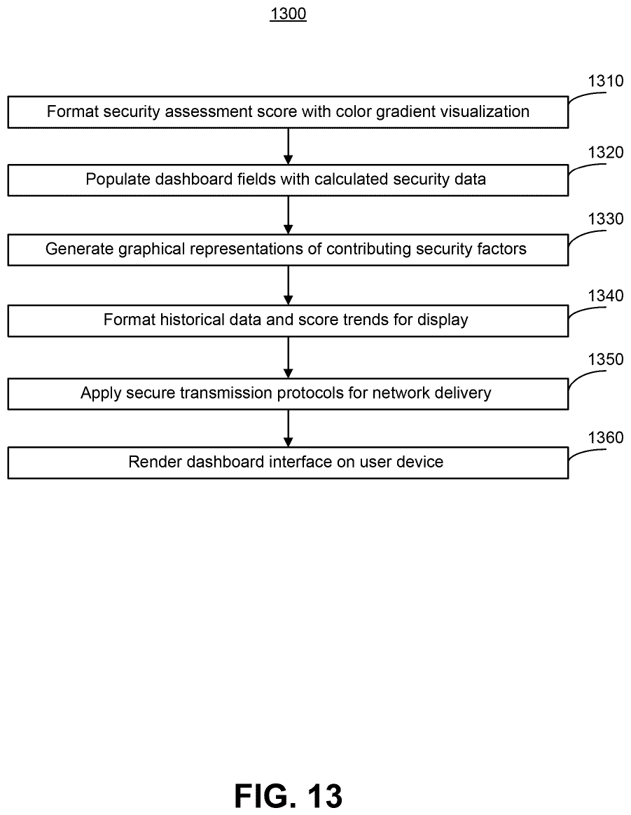

FIG. 13 is a flow chart of example dashboard data processing and display operations, consistent with some disclosed embodiments. In some embodiments, the steps of FIG. 13 may be performed by the security assessment system in conjunction with display output 530.

At step 1310, the security assessment score calculated by the score calculator may be formatted with color gradient visualization to enhance user interpretation. This step may involve overlaying the security assessment score on a color gradient that indicates whether the security assessment score is associated with better or worse security hygiene. The color gradient visualization may provide immediate visual feedback about security performance using intuitive color coding schemes. For example, a display of a worse security score may place the score on a red portion of a color gradient, while a display of a better security score may place the score on a green portion of a color gradient using web-based visualization libraries or graphical rendering frameworks. In some embodiments, multi-tier color schemes may be utilized to provide more granular visual distinction between different security performance levels. According to some exemplary embodiments, accessibility-compliant color palettes may be employed to enhance usability by ensuring proper contrast and readability for users with visual impairments. This process may help ensure intuitive score interpretation which facilitates quick assessment of application security status.

At step 1320, dashboard fields may be populated with calculated security data to provide comprehensive security information display. This step may involve organizing and formatting the security assessment data, metadata elements, and calculated metrics into structured dashboard components for user consumption. The dashboard population process may utilize the security assessment score to populate fields associated with the dashboard data categories. For example, dashboard data associated with open issues may include issue ID, issue name, overall issue rating, issue status, repeat issue indicators, target remediation date, and days past due information using data binding techniques or template-based rendering systems. In some embodiments, dynamic field updating mechanisms may be utilized to ensure real-time accuracy of displayed security information. According to some exemplary embodiments, customizable field arrangements may be employed to enhance user experience by allowing personalization of dashboard layout and content priorities.

At step 1330, graphical representations of contributing security factors may be generated to illustrate score composition. This step may involve creating visual displays that present factors associated with better or worse security scores, such as the number of open issues, open policy exceptions, open vulnerabilities, and incidents in the past 12 months. The graphical representation process may implement data visualization techniques to convert security metrics into comprehensible charts and graphs. For example, bar charts, pie charts, trend lines, or heat maps may be used to display contributing factors with color coding to aid display and interpretation of the data using charting libraries or visualization frameworks. In some embodiments, interactive visualization elements may be utilized to allow users to explore specific security aspects in greater detail. According to some exemplary embodiments, drill-down capabilities may be employed to enhance analysis by enabling users to investigate the underlying data behind graphical representations.

At step 1340, historical data and score trends may be formatted for display to provide temporal context and performance tracking. This step may involve organizing chronological security assessment information to show performance trends and historical comparisons over time. The historical formatting process may utilize the score history data to create timeline visualizations and trend analysis displays. For example, line graphs, trend charts, or historical comparison tables may be used to display historical data and historical security scores using time-series visualization techniques or temporal data presentation frameworks. In some embodiments, configurable time period selection may be utilized to allow users to focus on specific historical ranges for analysis. According to some exemplary embodiments, statistical trend indicators may be employed to enhance insight by highlighting improvement or degradation patterns in security performance over time. In some embodiments, this step may involve generating score trendline visualizations that graphically represent security score changes over time, enabling users to identify improvement or degradation patterns. The trendline visual may be incorporated into a dashboard display, providing immediate visual feedback on security posture trajectory.

At step 1350, secure transmission protocols may be applied for network delivery to protect sensitive security assessment information. This step may involve implementing encryption and security measures to ensure the ongoing privacy and security of the security assessment score and plurality of dashboard data during network transmission. The secure transmission process may utilize encrypted or otherwise secure network protocols to protect data integrity and confidentiality. For example, HTTPS encryption, TLS protocols, or VPN connections may be used to secure the transmission of security assessment results using cryptographic techniques or secure communication frameworks. In some embodiments, data masking or tokenization approaches may be utilized to provide additional protection for sensitive security information during transmission. According to some exemplary embodiments, authentication and authorization mechanisms may be employed to enhance security by ensuring that only authorized users can access transmitted security assessment data.

At step 1360, the dashboard interface may be rendered on the user device to provide final presentation of security assessment results. This step may involve displaying the formatted security assessment information through a graphical user interface that presents comprehensive security analysis in an accessible format. The rendering process may present the dashboard interface including security assessment scores, graphical representations, historical trends, and detailed security metrics. For example, web-based interfaces, mobile applications, or desktop dashboard applications may be used to display security assessment information using responsive design frameworks or cross-platform rendering technologies. In some embodiments, adaptive interface designs may be utilized to optimize display quality across different device types and screen sizes. According to some exemplary embodiments, real-time update capabilities may be employed to enhance currency by automatically refreshing dashboard content when new security assessment data becomes available.

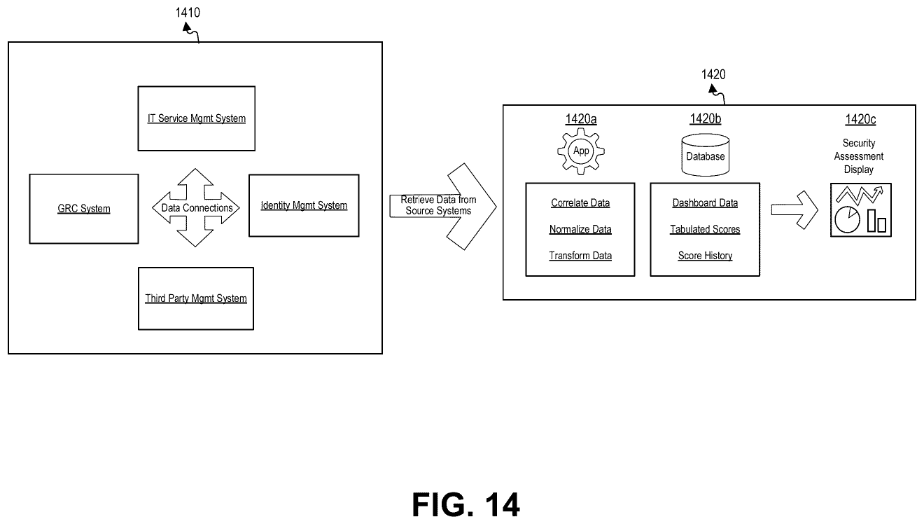

FIG. 14 is a data flow diagram showing an exemplary security assessment system for applications, consistent with some disclosed embodiments. As shown in the figure, the system environment may include source systems 1410 and a security assessment system 1420, with subcomponents including an application 1420a, a database 1420b, and a security assessment display 1420c.

The source systems 1410 may include multiple categories of security-related information systems that may provide input data for security assessment operations. The IT service management system may include application inventory and information data as well as service and incident information data. The governance, risk, and compliance (GRC) system may include issue management data, policy exceptions data, vulnerability management data, and risk and data elements. The identity management system may include onboarded applications data and user and entitlement information. The third-party risk management system may include third-party inventory and information data, risk and data elements, and issues and findings data. These source systems may be responsible for separately managing and controlling security data associated with applications, with security data across applications related to given risk factors being pooled and stored with source systems having expertise directed to the specific risk factors.

The security assessment system 1420 may serve as the central processing component that receives data from source systems 1410 performs data processing operations including receiving, correlating, normalizing, and transforming data, as explained in further detail before. It may, for example, receive data from the source systems through data connections and performs multiple data processing operations; retrieve data from source systems using secure communication protocols and standardized data transfer methods; correlate data using application codes as primary keys to establish proper relationships between security assessment data elements and their associated metadata; normalize data by applying uniform security data assessment criteria to ensure consistency across different data sources and formats; and transform data by converting diverse security indicators into standardized formats suitable for security assessment calculations.

The application 1420a may be the target application being assessed for security hygiene and may provide application metadata elements to the security assessment system. The application may respond to requests for metadata information including ITSM data elements, identity and access management data elements, and third-party management data elements that provide contextual information for security assessment calculations.

The database 1420b may store multiple categories of information required for security assessment operations. Dashboard data may include display configurations, visualization parameters, and presentation templates associated with the prepared set of security assessment criteria. Tabulated scores may include previously calculated metrics and baseline scores associated with applications and security assessment criteria. Score history may include chronological security assessment results that enable trend analysis and performance tracking over time.

The security assessment display 1420c may provide the final presentation interface where security assessment results are displayed to users through graphical user interfaces. The display may receive processed security assessment scores and dashboard data from the security assessment system and present comprehensive security analysis in accessible visual formats including color-coded scores, graphical representations of contributing factors, and historical trend displays.

The data flow shown in FIG. 14 illustrates how security assessment information may move from distributed source systems through centralized processing operations to final user presentation, enabling organizations to understand and manage application security posture through comprehensive assessment and visualization capabilities.

FIG. 15A shows an exemplary user interface for displaying and interacting with application security assessments, consistent with disclosed embodiments. As shown in the figure, the graphical user interface may include multiple sections that present comprehensive security assessment information for a selected application through the security assessment display component.

The interface header may include navigation tabs for “Security Scorecard-App” and “Security Scorecard-Overview” views, allowing users to switch between individual application assessments and system-wide security overview information. An application lookup section may require users to select a specific application asset using a mnemonic code before security assessment information is displayed, with options to choose from available applications in the system.

The application metadata section may display contextual information retrieved from the application including application mnemonic (AAC), application name (Advanced Authentication), creation date, installation status, hosting environment, owning risk unit name, and application ownership details including CIO, tech director, and tech manager information. Additional metadata may include risk unit code, data classification level, internet-facing status, inherent risk rating, recovery time objective, and links to design documentation.

The security assessment score may be prominently displayed as a numerical value (79 in this example) representing the application's security hygiene on a 0-100 scale (although any other range or format may be used). The score may be described as a custom score derived from security issues identified on the dashboard page using a points-based calculation methodology.

The open issues by rating section may display dashboard data for current security issues organized by severity levels including low, medium, and high priority categories. Each issue entry may include fields such as issue ID, issue name, overall issue rating, issue status, repeat issue indicators, target remediation date, and days past due for remediation as specified in the dashboard data requirements.

The open policy exceptions by rating section may present policy deviation information including policy exception ID, summary title, risk rating, policy subsection references, planned outcomes, approval dates, target remediation dates, and days past due calculations. This section may organize policy exceptions by severity to highlight the most critical deviations requiring attention.

The open vulnerabilities by rating section may categorize security vulnerabilities by severity levels and internal/external classifications, showing vulnerability counts for high, medium, and low priority findings. Individual vulnerability entries may include vulnerability finding names, VMT severity ratings, finding status, finding state, pre-existing vulnerability indicators, target remediation dates, and days past due information.

The incidents past 12 months section may display historical incident data organized by priority levels (P2, P3, P4) with detailed incident records including incident numbers, short descriptions, priority classifications, incident state, opened dates, and closed dates to provide operational context for security assessment.

The IRR risk elements section may present identity and risk-related metadata including data classification indicators for PII, PCI, PHI, and other confidential data types, along with operational characteristics such as internet-facing status, customer-facing status, third-party hosting arrangements, and infrastructure requirements.

The identity and application security section may display user access information including the number of users or logon IDs, onboarding status for identity management systems, and PIDM user counts to provide context about the application's user base and access management integration.

The linked third-party engagements section may present comprehensive third-party relationship information including vendor names, relationship IDs, relationship status, criticality indicators, inherent risk ratings, security assessment results, and security review dates. Additional details may include data classification, record counts, hosting arrangements, geographic considerations, and funds handling information.

The open security findings for linked third-party engagements section may display current security issues associated with third-party relationships, organized by priority levels and including vendor names, relationship IDs, remediation IDs, issue titles, priority classifications, status information, creation dates, due dates, and days past due calculations.

The interface design may utilize color coding and visual indicators to enhance data interpretation and may provide interactive elements for detailed exploration of specific security assessment components, enabling users to understand application security posture through comprehensive data presentation and analysis capabilities.

FIG. 15B shows an exemplary user interface for displaying overview security assessment information across multiple applications, consistent with disclosed embodiments. As shown in the figure, the graphical user interface may present summary security assessment data through the security assessment display component in an overview format rather than individual application details.

The interface header may include the same navigation tabs as FIG. 15A, with “Security Scorecard-App” and “Security Scorecard-Overview” options, but with the “Overview” tab currently selected to display system-wide security assessment information. The main heading identifies this as the “Application Security Overview” interface.

The overview display may include three primary dashboard sections that present overview data as described in the specification. The first section, “Top 15 Apps w/Highest Security Scores by LOB,” may display applications with the highest security scores organized by line of business (LOB), using visual representations such as horizontal bar charts to show the distribution of high-risk applications across different organizational units. The chart may show percentage breakdowns with segments representing 42%, 32%, 22%, and 4% for different categories or organizational divisions.

The second section, “Top 15 Apps w/Score Changed >20 Points By LOB,” may present applications with security scores that have changed greater than a given threshold over a given time period, specifically focusing on applications where scores have changed by more than 20 points. This section may utilize similar bar chart visualizations to display the distribution of applications experiencing significant score changes across different lines of business, with the same percentage distributions as the first section.

The third section, “Number of Apps w/Security Scores >X by LOB,” may show the number of applications with security scores above a given threshold, organized by line of business. This display may help users understand the overall security posture distribution across organizational units and identify areas requiring attention or improvement.

Each section may utilize graphical representations including bar charts or similar visualizations to present summary information in an easily interpretable format. The consistent percentage distributions (42%, 32%, 22%, 4%) across all three sections may indicate standardized organizational divisions or risk categories used throughout the security assessment system.

The overview interface may provide high-level insights that enable users to identify trends, patterns, and areas of concern across the entire application portfolio, complementing the detailed individual application view shown in FIG. 15A. This overview capability may support strategic decision-making and resource allocation for security improvement initiatives across the organization through improvements over conventional approaches.

The overview interface may, for example, update when new security assessment scores are calculated by score calculator 660, reflecting changes in real-time as applications undergo security assessments and as new security data is processed through the system. It may aggregate security scores by executing database queries against normalized data that originated from disparate source systems (e.g., ITSM, GRC, TPRM, and identity management systems), automatically grouping applications using the LOB metadata elements retrieved by metadata processor 640. It may perform mathematical comparisons between current scores and historical baselines for numerous applications simultaneously, executing threshold detection algorithms to identify which applications meet the criteria for each dashboard section (highest scores, score changes exceeding 20 points, or scores above configurable thresholds). The percentage calculations may dynamically adjust as correlator 620 associates new security data with applications and normalizer 630 standardizes incoming data from various formats, enabling the interface to present a unified organizational view despite the heterogeneous nature of the underlying source systems. The interface may thus aggregate and transform security data from multiple source systems into actionable organizational intelligence, enabling security teams to monitor which organizational units have the highest concentration of high-risk applications and track significant score changes that may indicate emerging security concerns or successful remediation efforts.

FIG. 15C shows an exemplary user interface for displaying security score trendline and contributing factors to score movement, consistent with disclosed embodiments. As shown in the figure, the graphical user interface may present temporal security assessment analysis through the security assessment display component with enhanced visualization of score changes and their underlying causes.

The security score trendline section may display a rolling three-month (or any other suitable period) visualization of the application's security assessment scores using a line graph format, although any other desired format may be used. The trendline may plot security scores on a vertical axis ranging from 0 to 100 points against a temporal horizontal axis showing the rolling time period. The continuous line visualization may enable users to identify patterns, trends, or significant changes in security posture over the displayed timeframe.

The current score indicator may display the most recent security assessment score (87 in this example) with associated metadata including the application, date, and total score value. This current score representation may provide immediate context for interpreting the trendline's terminal point.

The contributing factors annotation may identify specific security elements that have influenced score movements during the displayed period. The interface may utilize visual markers such as triangular indicators on the trendline to highlight points where significant changes occurred. In this example, “Vulnerabilities Contributed” may be displayed with an upward-pointing triangle symbol, indicating that vulnerability remediation or changes in vulnerability status contributed to score improvement at that temporal point.

The historical trendline navigation option may further provide users with the ability to access extended historical views beyond the rolling three-month window. A “Go To Historical Trendline” control may enable users to explore longer-term security posture trends, supporting comprehensive trend analysis and performance evaluation over extended periods.

The trendline visualization may utilize color coding or shading to enhance interpretation, such as gradient backgrounds that transition from red (lower scores) through amber (moderate scores) to green (higher scores), providing immediate visual feedback about security posture changes. Interactive elements may enable users to hover over or select specific points on the trendline to reveal detailed information about score changes and contributing factors at those temporal positions.

This trending interface may update dynamically as new security assessment scores are calculated by the score calculator, incorporating the most recent assessment results into the rolling window display. The combination of trendline visualization and contributing factor identification may enable security teams to understand how their application's security posture is changing over time, as well as which specific security elements are driving those changes, facilitating targeted remediation efforts and strategic security improvements.

FIG. 15D shows an exemplary user interface for displaying architecture exceptions contributing to security assessment scoring, consistent with disclosed embodiments. As shown in the figure, the graphical user interface may present architecture exception data through the security assessment display component as a scored section that impacts the overall security assessment calculation.

The architecture exceptions by risk visualization may display a chart (e.g., a donut chart) categorizing architecture exceptions according to their risk levels. The chart may show the distribution of exceptions across Low (4 in this example), Medium (1 in this example), and High (0 in this example) risk categories, with the center displaying “Total EA: 5” to indicate the aggregate number of architecture exceptions. The donut chart segments may utilize color coding consistent with risk severity levels, such as green for Low, amber for Medium, and red for High risk exceptions.

The architecture exceptions detail table may present information about each architecture exception impacting the application's security posture. The table structure may include multiple columns providing detailed exception tracking and management information:

The NUMBER column may display unique architecture exception identifiers (such as AE12345 in this example) that enable tracking and reference of specific exceptions within the organization's architecture governance systems.

The EXCEPTION TYPE column may categorize the nature of the architecture deviation, such as “Design Pattern Violation” shown in this example, indicating departures from established enterprise architecture standards, approved design patterns, or architectural principles.

The RISK column may indicate the assessed risk level (Low, Medium, or High) associated with each architecture exception, directly correlating to the penalty points applied in the security assessment score calculation.

The CURRENT STATUS column may display the present state of the exception within the governance workflow, such as “Exception Granted” indicating formal approval of the deviation from standard architecture patterns.

The SYS CREATED ON column may show the system timestamp (e.g., using the MM/DD/YYYY format) when the architecture exception was initially recorded in the architecture database or GRC system, providing historical context for exception duration.

The REVIEW COMPLETED column may indicate when formal architectural review processes were concluded (e.g., using the MM/DD/YYYY format), documenting governance oversight of the exception.

The RESOLUTION STATUS column may provide detailed disposition information, such as “Exception Granted. No FND Required” in this example, indicating that the exception has been formally accepted without requiring additional findings or remediation actions.

The EXPECTED RESOLUTION DATE column may display target dates (e.g., using the MM/DD/YYYY format) for addressing or remediating architecture exceptions that require correction, enabling tracking of remediation timelines.

The POLICY EXCEPTION column may indicate relationships to formal policy exceptions, showing either “N/A” when no policy exception exists or a reference identifier when the architecture exception is associated with a documented policy deviation.

The architecture exceptions section may contribute scored penalty points to the overall security assessment calculation using similar weighting methodology as applied to open issues and policy exceptions. For example, low-risk architecture exceptions may incur 5 penalty points, medium-risk exceptions 10 points, and high-risk exceptions 15 points, with additional penalties applied for exceptions exceeding their expected resolution dates.

The data displayed in this section may be retrieved from specialized architecture governance systems, enterprise architecture databases, or integrated GRC platforms that maintain repositories of approved architecture patterns and track deviations from established standards. The integration of architecture exception data into the security assessment framework may enable organizations to quantify the security impact of architectural design decisions and non-standard implementations.

FIG. 15E shows an exemplary user interface for displaying ineffective controls contributing to security assessment scoring, consistent with disclosed embodiments. As shown in the figure, the graphical user interface may present ineffective control data through the security assessment display component as a scored section that impacts the overall security assessment calculation.

The ineffective controls may encompass various control types including preventive controls that fail to prevent unauthorized activities, detective controls that do not identify security events, corrective controls that cannot remediate identified issues, and compensating controls that inadequately address risk gaps. Each control type may be evaluated through standardized testing methodologies such as walkthroughs, sample testing, or automated control monitoring.

The ineffective controls count indicator may display the total number of controls identified as ineffective (1 in this example) using any appropriate visualization (a colored box in this example). The indicator may utilize color coding to reflect severity, such as blue for low counts, amber for moderate counts, or red for high counts of ineffective controls, providing immediate visual feedback about control effectiveness issues.

The ineffective controls detail table may present comprehensive information about enterprise controls that have failed routine testing or validation procedures. The table structure may include multiple columns providing detailed control tracking and remediation information:

The CNTRL NUMBER column may display unique control identifiers (such as C12345 in this example) that correspond to the organization's control framework numbering system, enabling precise tracking and reference of specific controls within the GRC system or control testing platforms.

The CONTROL OWNER column may identify the individual or role responsible for the control's implementation and effectiveness, shown as “First Last Name” in this example, establishing accountability for control remediation and ongoing maintenance.

The CONTROL NAME column may provide a descriptive title for the control indicating the specific control objective or process being evaluated for effectiveness.

The CONTROL DESCRIPTION column may present detailed information about the control's purpose, implementation, and testing requirements, providing context for understanding the control's role in the organization's risk management framework.

The ineffective controls section may contribute scored penalty points to the overall security assessment calculation based on the criticality and nature of the failed controls. For example, operational controls deemed ineffective may incur 5 penalty points, technology controls 10 points, and security controls 15 points, reflecting their relative importance to the application's security posture. Additional penalties may be applied for controls that remain ineffective beyond established remediation timelines.

The data displayed in this section may be retrieved from integrated GRC systems, control testing platforms, or compliance management systems that maintain repositories of enterprise controls and track their effectiveness through routine testing cycles. Controls may be classified as ineffective when they fail testing procedures, do not operate as designed, or cannot demonstrate their intended risk mitigation capabilities.

This ineffective controls interface may update dynamically as control testing cycles are completed, remediation efforts restore control effectiveness, or new control failures are identified through ongoing monitoring activities. The integration of control effectiveness data into the security assessment framework may enable organizations to quantify the security impact of control failures and prioritize remediation efforts based on their contribution to overall security risk.

FIG. 15F shows an exemplary user interface for displaying extranet connectivity information as contextual security assessment data, consistent with disclosed embodiments. As shown in the figure, the graphical user interface may present extranet connection data through the security assessment display component as an informational section that provides security context without directly contributing penalty points to the score calculation.

The extranet connectivity information may encompass various types of external connections including API integrations with partner systems, secure file transfer protocol (SFTP) connections for data exchange, virtual private network (VPN) tunnels for B2B communications, web service endpoints for real-time data synchronization, and electronic data interchange (EDI) connections for structured business document exchange. The extranet connectivity count indicator may display the total number of external network connections associated with the application (1 in this example) using a numerical indicator.

The extranet connectivity detail table may present comprehensive information about business-to-business (B2B) connections, external data integrations, and third-party network connectivity associated with the application. The table structure may include multiple columns providing detailed connection tracking and risk context information:

The NAME column may identify the external entity or connection point, displayed as “Company Name” in this example, providing clear identification of the external organization, partner, vendor, or service provider with which the application maintains network connectivity.

The INSTALL STATUS column may indicate the current operational state of the extranet connection, shown as “Installed” in this example, documenting whether the connection is active, pending installation, decommissioned, or in a transitional state within the network architecture.

The OWNING LOB column may identify the line of business responsible for the extranet connection, displayed as “LOB1” in this example, establishing organizational ownership and accountability for the external connectivity relationship and its associated business purposes.

The PRIMARY LOCATION column may specify the primary geographic or network location where the extranet connection terminates, shown as “Building/Location” in this example, providing physical or logical endpoint information for the external connection.

The SECONDARY LOCATION column may indicate backup or redundant connection points for the extranet connectivity, also displayed as “Building/Location” in this example, documenting failover capabilities or distributed connection architectures that support business continuity.

The extranet connectivity section may not directly contribute penalty points to the security assessment score calculation, but may nonetheless provide critical context for interpreting other scored elements. The presence of external connections may influence the risk profile of vulnerabilities, the criticality of certain controls, and the potential impact of security incidents. Security teams may use this information to prioritize remediation efforts for applications with extensive external connectivity or to implement additional compensating controls for externally-facing systems.

The data displayed in this section may be retrieved from network configuration management databases, integration platforms, API management systems, or specialized B2B connectivity repositories that maintain inventories of external connections and their associated metadata. This information may be correlated with firewall rules, network segmentation policies, and data flow diagrams to provide comprehensive visibility into the application's external communication patterns.

This extranet connectivity interface may update dynamically as new external connections are established, existing connections are modified, or B2B relationships are terminated. The inclusion of extranet connectivity information in the security assessment dashboard may enable organizations to maintain awareness of external exposure points and consider the broader security implications of interconnected business ecosystems.

FIG. 16 shows an exemplary methodology for application security assessment scoring calculations, consistent with disclosed embodiments. As shown in the figure, the scoring methodology may provide detailed guidance for calculating security assessment scores from security assessment data elements, security assessment metadata elements, and application metadata elements as described herein.

The scoring methodology may utilize a penalty-based calculation system where points are assigned to various security issues and deducted from a total possible score to generate the final security assessment score. The methodology may organize security assessment data elements into distinct categories, each with specific scoring criteria and maximum penalty limits.

The open issues category may assign penalty points based on issue rating levels including low (5 points), medium (10 points), and high (15 points) ratings. Additional penalty points may be applied if issues are past their target remediation dates, with the same point values added for overdue items. The category maximum may be set at 200 points (although any other maximum may be used) to prevent any single category from dominating the overall score calculation.

The open policy exceptions category may utilize identical scoring criteria as the open issues category, with low (5 points), medium (10 points), and high (15 points) penalty values, plus additional penalties for past due exceptions. This category may also have a maximum penalty limit of 200 points to maintain balanced scoring across different security assessment factors.

The open vulnerabilities category may implement more granular scoring based on both severity levels and internal/external classifications. Internal vulnerabilities may be scored as low (2 points), medium (7 points), high (12 points), and critical (12 points), while external vulnerabilities may receive higher penalty values of low (5 points), medium (10 points), high (15 points), and critical (15 points). The category maximum may be set at 200 points to maintain scoring balance.

The incidents past 12 months category may focus on high-priority incidents including P1 (10 points) and P2 (5 points) classifications, with lower priority incidents P3 and P4 receiving reduced penalty values of 7 points and 5 points respectively. This category may have a maximum penalty of 100 points, reflecting the historical nature of incident data.

The open or risk accepted third-party findings category may assign penalty points of 5 points for P4 priority, 7 points for P3 priority, 10 points for P2 priority, and 15 points for P1 priority findings. The category maximum may be set at 200 points to maintain consistency with other major scoring categories.

The final score calculation may utilize the formula: (1−(Sum of Items not exceeding category max/Total Possible Score))×100, where the total possible score is 900 points across all categories. This calculation may produce security assessment scores ranging from 0 to 100, with higher values indicating better security hygiene as specified in the security assessment requirements.

The methodology may include color coding thresholds to enhance visual interpretation of security assessment scores, with green representing scores of 75 and above (indicating good security hygiene), amber representing scores between 50-75 (indicating moderate security concerns), and red representing scores below 50 (indicating significant security issues requiring attention). These thresholds may be adjustable based on organizational tolerance and population characteristics.

The scoring methodology shown in FIG. 16 may provide the mathematical framework for converting diverse security assessment data into numerical scores that enable consistent comparison and evaluation of application security posture across an organization's application portfolio.

FIG. 17 shows an exemplary user interface for multi-application comparison view enabling simultaneous security assessment analysis across multiple applications, consistent with disclosed embodiments. As shown in the figure, the graphical user interface may present a consolidated comparison view through the security assessment display component that enables rapid assessment of relative security posture across selected applications.

The application selector may display “(Multiple values)” in a dropdown control, indicating that multiple applications have been selected for simultaneous comparison. This selector may enable users to choose specific applications from the organization's portfolio for side-by-side security assessment analysis, supporting portfolio-level decision making and resource prioritization.

The application summary table may present high-level information for each selected application in a condensed format. The table columns may include:

The APP column displaying application mnemonics serving as unique identifiers for each application in the comparison set.

The NAME column showing descriptive application names (“App Name” entries) providing human-readable identification for each application.

The STATUS column indicating operational status, shown as “Installed” for active applications, with tier ratings (3, 2, 2 in this example) reflecting application criticality or classification levels.

The CIO, APP OWNER, and START DATE columns providing organizational context including executive ownership (“CIO Name”), application ownership (“Owner Name”), and implementation dates (e.g., using the MM/DD/YYYY format), enabling users to understand governance and accountability structures.

The DSR column displaying security assessment scores using color-coded boxes—green (100 score for AAA), green (96 score for BBB), and amber (70 score for CCC)—providing immediate visual comparison of security hygiene across applications. The color coding may follow standard thresholds with green indicating strong security posture, amber indicating moderate concerns, and red indicating significant issues.

The scored sections summary area may display aggregated counts for the main security assessment categories that contribute to score calculations:

The ISSUES section showing counts by severity level, with “No Records to Display” indicating applications without open issues, enabling quick identification of applications with outstanding security concerns.

The PEs (Policy Exceptions) section presenting exception counts, similarly showing “No Records to Display” when no exceptions exist, facilitating rapid assessment of policy compliance across the comparison set.

The VULNERABILITIES section displaying vulnerability counts categorized by severity (High, Medium, Low), with specific counts for each selected application (AAA showing High: 1, BBB showing High: 2 and Low: 5, in this example), or alternatively displaying “No Records to Display” when no vulnerabilities exist for selected applications, enabling prioritization of vulnerability remediation efforts.

The P1/P2 section presenting high-priority findings or incidents, with counts by priority level (P2: 2 and P2: 14 shown for different applications), or alternatively displaying “No Records to Display” when no high-priority incidents exist, highlighting operational security events requiring attention.

The ARCHITECTURE EXCEPTIONS section showing “No Records to Display” when applications comply with architecture standards, or displaying exception counts when deviations exist.

The INEFFECTIVE CONTROLS section similarly presenting “No Records to Display” or control failure counts, enabling assessment of control environment effectiveness across applications.

This multi-application view may support strategic security management by enabling portfolio-wide visibility, facilitating benchmarking across similar applications, and supporting executive reporting on organizational security posture trends. The streamlined presentation of scored elements may enable rapid decision-making while maintaining focus on the quantitative security metrics that drive the security assessment scoring methodology.

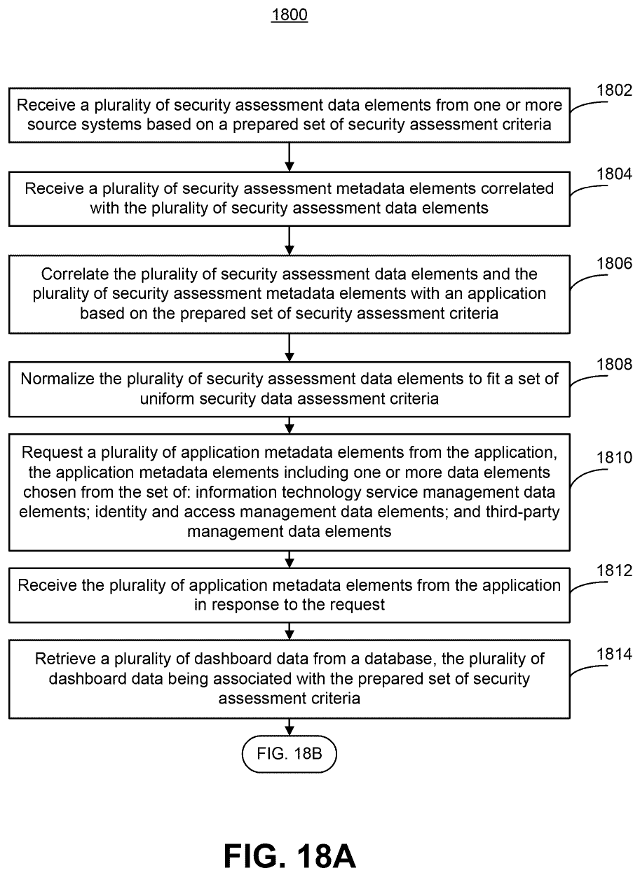

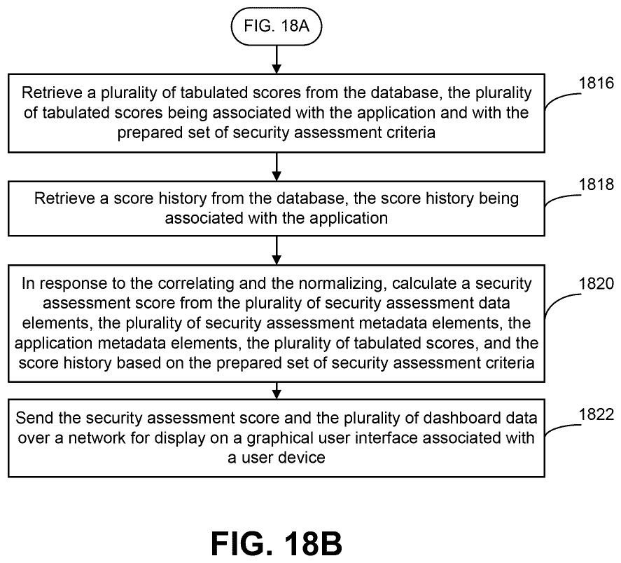

FIG. 18 is a flow chart showing an exemplary method for application security assessment, consistent with some disclosed embodiments. As shown in the figure, the method may comprise a series of sequential steps that may collectively enable comprehensive security assessment of applications through data collection, processing, and presentation operations.

At step 1802, the method may involve receiving a plurality of security assessment data elements from one or more source systems based on a prepared set of security assessment criteria. This initial step may establish the foundation for security assessment by gathering relevant security information from various organizational systems.

At step 1804, the method may involve receiving from the one or more source systems a plurality of security assessment metadata elements correlated with the plurality of security assessment data elements. This step may provide contextual information that enhances the interpretation and analysis of the security assessment data.

At step 1806, the method may involve correlating the plurality of security assessment data elements and the plurality of security assessment metadata elements with an application based on the prepared set of security assessment criteria. This correlation step may ensure proper association between security data and the specific application being assessed.

At step 1808, the method may involve normalizing the plurality of security assessment data elements to fit a set of uniform security data assessment criteria. This normalization process may standardize diverse data formats to enable consistent processing and analysis.

At step 1810, the method may involve requesting a plurality of application metadata elements from the application, where the application metadata elements may include one or more data elements chosen from the set of information technology service management data elements, identity and access management data elements, and third-party management data elements. This step may gather application-specific contextual information.

At step 1812, the method may involve receiving the plurality of application metadata elements from the application in response to the request. This step may complete the application metadata collection process initiated in step 1810.

At step 1814, the method may involve retrieving a plurality of dashboard data from a database, where the plurality of dashboard data may be associated with the prepared set of security assessment criteria. This step may access stored presentation and visualization configurations. The method then continues to step 1816 in FIG. 18B.

At step 1816, the method may involve retrieving a plurality of tabulated scores from the database, where the plurality of tabulated scores may be associated with the application and with the prepared set of security assessment criteria. This step may gather previously calculated metrics for comparison and analysis.

At step 1818, the method may involve retrieving a score history from the database, where the score history may be associated with the application. This step may provide historical context for trend analysis and performance tracking.

At step 1820, the method may involve calculating a security assessment score from the plurality of security assessment data elements, the plurality of security assessment metadata elements, the application metadata elements, the plurality of tabulated scores, and the score history based on the prepared set of security assessment criteria, in response to the correlating and the normalizing operations. This calculation step may integrate all collected data to produce a comprehensive security assessment metric.

At step 1822, the method may involve sending the security assessment score and the plurality of dashboard data over a network for display on a graphical user interface associated with a user device. This step may deliver the security assessment results to users for review and decision-making.

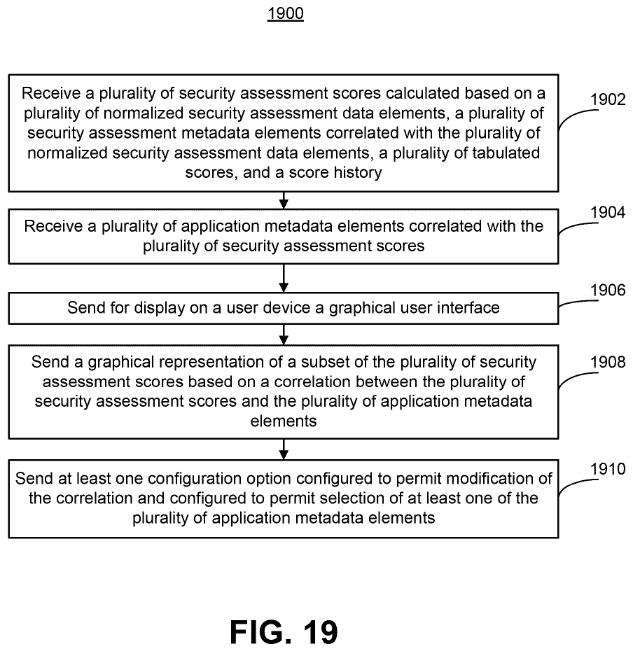

FIG. 19 is a flow chart of example graphical user interface operations for security assessment display, consistent with some disclosed embodiments. In some embodiments, the steps of FIG. 19 may be performed by the security assessment display component described herein.

At step 1902, a plurality of security assessment scores calculated based on a plurality of normalized security assessment data elements, a plurality of security assessment metadata elements correlated with the plurality of normalized security assessment data elements, a plurality of tabulated scores, and a score history may be received from the security assessment system. This step may involve obtaining previously computed security assessment results that have undergone the complete calculation process including data normalization, correlation, and score computation operations. The received security assessment scores may represent comprehensive evaluations of application security hygiene derived from multiple data sources and calculation methodologies. For example, the system may receive numerical scores ranging from 0 to 100 that have been calculated using weighted averaging or machine learning models applied to normalized security assessment data, metadata elements, tabulated scores, and historical performance data. In some embodiments, batch processing techniques may be utilized to efficiently handle multiple security assessment scores representing different applications or assessment periods. According to some exemplary embodiments, data validation routines may be employed to enhance reliability by confirming that received security assessment scores meet quality standards and calculation consistency requirements. This process may help ensure accurate score foundation which facilitates meaningful security assessment presentation and analysis.

At step 1904, a plurality of application metadata elements correlated with the plurality of security assessment scores may be received from the security assessment system. This step may involve obtaining contextual information that provides organizational and operational details about the applications associated with the security assessment scores received in step 1902. The application metadata elements may include information such as application names, organizational units, risk classifications, hosting environments, and other contextual factors that enable meaningful grouping and analysis of security assessment results. For example, the system may receive metadata including line of business classifications, application criticality levels, data sensitivity ratings, and operational characteristics that can be used to organize and filter security assessment scores for presentation purposes. In some embodiments, metadata correlation techniques may be utilized to efficiently associate contextual information with corresponding security assessment scores while maintaining proper data relationships. According to some exemplary embodiments, completeness validation may be employed to enhance data quality by identifying missing metadata elements that could affect presentation accuracy and user analysis capabilities.

At step 1906, a graphical user interface may be sent for display on a user device, where the interface includes specific display components and interactive elements described in subsequent steps. This step may involve initiating the transmission of comprehensive user interface components that enable visualization and interaction with security assessment information. The graphical user interface may provide users with tools to explore, analyze, and configure security assessment data presentation according to their specific needs and organizational requirements. For example, the system may prepare web-based interfaces, dashboard applications, or mobile-responsive displays that present security assessment scores alongside relevant contextual information and interactive controls. In some embodiments, responsive design frameworks may be utilized to ensure optimal display quality across different device types and screen sizes. According to some exemplary embodiments, accessibility compliance features may be employed to enhance usability by ensuring proper contrast, navigation, and readability for users with various accessibility needs.

At step 1908, a graphical representation of a subset of the plurality of security assessment scores based on a correlation between the plurality of security assessment scores and the plurality of application metadata elements may be included in the graphical user interface. This step may involve creating visual displays that present filtered or organized security assessment information according to relationships between scores and application characteristics. The graphical representation may utilize various visualization techniques such as charts, graphs, tables, or dashboard displays to present security assessment scores in meaningful groupings based on application metadata correlations. For example, the system may display security assessment scores organized by line of business, risk classification, or application type using bar charts, pie charts, scatter plots, or tabular presentations that highlight patterns and trends in security performance across different application categories. In some embodiments, dynamic visualization libraries may be utilized to create interactive charts and graphs that allow users to explore different views and perspectives of security assessment data. According to some exemplary embodiments, color coding and visual indicators may be employed to enhance interpretation by providing immediate visual feedback about security performance levels and comparative rankings across application groupings.

At step 1910, at least one configuration option configured to permit modification of the correlation and configured to permit selection of at least one of the plurality of application metadata elements may be included in the graphical user interface. This step may involve providing interactive controls that enable users to customize the presentation and analysis of security assessment information according to their specific requirements and preferences. The configuration options may allow users to modify how security assessment scores are correlated with application metadata elements and to select which metadata elements are used for grouping, filtering, or analysis purposes. For example, the interface may include dropdown menus, checkboxes, radio buttons, or other interactive elements that permit users to choose specific application metadata categories such as organizational unit, risk level, or application type for correlation analysis and display purposes. In some embodiments, dynamic filtering mechanisms may be utilized to provide real-time updates to graphical representations as users modify correlation settings and metadata element selections. According to some exemplary embodiments, configuration persistence capabilities may be employed to enhance user experience by saving user preferences and custom correlation settings for future sessions, enabling consistent and personalized analysis workflows.

It is to be understood that the disclosed embodiments are not necessarily limited in their application to the details of construction and the arrangement of the components and/or methods set forth in the description and/or illustrated in the drawings and/or the examples. The disclosed embodiments are capable of variations, or of being practiced or carried out in various ways.

The disclosed embodiments may be implemented in a system, a method, and/or a computer program product. The computer program product may include a computer readable storage medium (or media) having computer readable program instructions thereon for causing a processor to carry out aspects of the present invention.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++or the like, and conventional procedural programming languages, such as the “C” programming language or similar programming languages. The computer readable program instructions may execute entirely on the user's computing device, partly on the user's computing device, as a stand-alone software package, partly on the user's computing device and partly on a remote computing device or entirely on the remote computing device or server. In the latter scenario, the remote computing device may be connected to the user's computing device through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computing device, special purpose computing device, or other programmable data processing apparatus to produce a machine, such that the instructions, which execute via the processor of the computing device or other programmable data processing apparatus, create means for implementing the functions/acts specified in the flowchart and/or block diagram block or blocks. These computer readable program instructions may also be stored in a computer readable storage medium that can direct a computing device, a programmable data processing apparatus, and/or other devices to function in a particular manner, such that the computer readable storage medium having instructions stored therein includes an article of manufacture including instructions that implement aspects of the function/act specified in the flowchart and/or block diagram block or blocks.

The computer readable program instructions may also be loaded onto a computing device, other programmable data processing apparatus, or other device to cause a series of operational steps to be performed on the computing device, other programmable apparatus or other device to produce a computer implemented process, such that the instructions that execute on the computing device, other programmable apparatus, or other device implement the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowcharts or block diagrams may represent a software program, segment, or portion of code, which includes one or more executable instructions for implementing the specified logical function(s). It should also be noted that, in some alternative implementations, the functions noted in the block may occur out of the order noted in the figures. Some steps may be deleted, added, or modified. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims. This listing of claims will replace all prior versions and listings of claims in the application:

1. A non-transitory computer-readable medium storing a set of instructions that, when executed by one or more processors, cause the one or more processors to perform operations comprising:
receive a plurality of security assessment data elements from one or more source systems based on a prepared set of security assessment criteria;
receive a plurality of security assessment metadata elements correlated with the plurality of security assessment data elements;
correlate the plurality of security assessment data elements and the plurality of security assessment metadata elements with an application based on the prepared set of security assessment criteria;
normalize the plurality of security assessment data elements to fit a set of uniform security data assessment criteria;
request a plurality of application metadata elements from the application, the application metadata elements including one or more data elements chosen from the set of:
information technology service management data elements;
identity and access management data elements; or
third-party management data elements;
receive the plurality of application metadata elements from the application in response to the request;
retrieve a plurality of dashboard data from a database, the plurality of dashboard data being associated with the prepared set of security assessment criteria;
retrieve a plurality of tabulated scores from the database, the plurality of tabulated scores being associated with the application and with the prepared set of security assessment criteria;
retrieve a score history from the database, the score history being associated with the application;
in response to the correlating and the normalizing, calculate a security assessment score from the plurality of security assessment data elements, the plurality of security assessment metadata elements, the application metadata elements, the plurality of tabulated scores, and the score history based on the prepared set of security assessment criteria; and
send the security assessment score and the plurality of dashboard data over a network for display on a graphical user interface associated with a user device.

2. The non-transitory computer-readable medium of claim 1, wherein the prepared set of security assessment criteria is unique to the one or more source systems.

3. The non-transitory computer-readable medium of claim 1, wherein the one or more source systems include at least one chosen from the set of:
an information technology service management system;
a governance, risk, and compliance (GRC) system;
a third-party risk management (TPRM) system; or
an identity management system.

4. The non-transitory computer-readable medium of claim 3, wherein the information technology service management system is one chosen from the set of:
an application inventory information system; or
a service and incident information system.

5. The non-transitory computer-readable medium of claim 3, wherein the GRC system is one chosen from the set of:
an issue management system;
a policy exceptions system;
a vulnerability management system; or
a risk and data elements system.

6. The non-transitory computer-readable medium of claim 3, wherein the TPRM system is one chosen from the set of:
a third-party inventory and information system;
a risk and data elements system; or
an issues and findings system.

7. The non-transitory computer-readable medium of claim 3, wherein the identity management system is one chosen from the set of:
an onboarded applications system; or
a user and entitlement information system.

8. A system comprising:
a memory storing instructions; and
a processor configured to execute the stored instructions to:
receive a plurality of security assessment data elements from one or more source systems based on a prepared set of security assessment criteria;
receive a plurality of security assessment metadata elements correlated with the plurality of security assessment data elements;
correlate the plurality of security assessment data elements and the plurality of security assessment metadata elements with an application based on the prepared set of security assessment criteria;
normalize the plurality of security assessment data elements to fit a set of uniform security data assessment criteria;
request a plurality of application metadata elements from the application, the application metadata elements including one or more data elements chosen from the set of:
information technology service management data elements;
identity and access management data elements; or
third-party management data elements;
receive the plurality of application metadata elements from the application in response to the request;
retrieve a plurality of dashboard data from a database, the plurality of dashboard data being associated with the prepared set of security assessment criteria;
retrieve a plurality of tabulated scores from the database, the plurality of tabulated scores being associated with the application and with the prepared set of security assessment criteria;
retrieve a score history from the database, the score history being associated with the application;
in response to the correlating and the normalizing, calculate a security assessment score from the plurality of security assessment data elements, the plurality of security assessment metadata elements, the application metadata elements, the plurality of tabulated scores, and the score history based on the prepared set of security assessment criteria; and
send the security assessment score and the plurality of dashboard data over a network for display on a graphical user interface associated with a user device.

9. The system of claim 8, wherein the prepared set of security assessment criteria is unique to the one or more source systems.

10. The system of claim 8, wherein the one or more source systems include at least one chosen from the set of:
an information technology service management system;
a governance, risk, and compliance (GRC) system;
a third-party risk management (TPRM) system; or
an identity management system.

11. The system of claim 10, wherein the information technology service management system is one chosen from the set of:
an application inventory information system; or
a service and incident information system.

12. The system of claim 10, wherein the GRC system is one chosen from the set of:
an issue management system;
a policy exceptions system;
a vulnerability management system; or a risk and data elements system.

13. The system of claim 10, wherein the TPRM system is one chosen from the set of:
a third-party inventory and information system;
a risk and data elements system; or an issues and findings system.

14. The system of claim 10, wherein the identity management system is one chosen from the set of:
an onboarded applications system; or
a user and entitlement information system.

15. A method comprising the steps of:
receiving a plurality of security assessment data elements from one or more source systems based on a prepared set of security assessment criteria;
receiving a plurality of security assessment metadata elements correlated with the plurality of security assessment data elements;
correlating the plurality of security assessment data elements and the plurality of security assessment metadata elements with an application based on the prepared set of security assessment criteria;
normalizing the plurality of security assessment data elements to fit a set of uniform security data assessment criteria;
requesting a plurality of application metadata elements from the application, the application metadata elements including one or more data elements chosen from the set of:
information technology service management data elements;
identity and access management data elements; or
third-party management data elements;
receiving the plurality of application metadata elements from the application in response to the request;
retrieving a plurality of dashboard data from a database, the plurality of dashboard data being associated with the prepared set of security assessment criteria;
retrieving a plurality of tabulated scores from the database, the plurality of tabulated scores being associated with the application and with the prepared set of security assessment criteria;
retrieving a score history from the database, the score history being associated with the application;
in response to the correlating and the normalizing, calculating a security assessment score from the plurality of security assessment data elements, the plurality of security assessment metadata elements, the application metadata elements, the plurality of tabulated scores, and the score history based on the prepared set of security assessment criteria; and
sending the security assessment score and the plurality of dashboard data over a network for display on a graphical user interface associated with a user device.

16. The method of claim 15, wherein the plurality of security assessment data elements include one or more data elements chosen from the set of:
an open issue;
an open policy exception;
an open vulnerability;
an incident;
a third-party engagement;
an architecture exception; or
an ineffective control.

17. The method of claim 16, wherein one or more of the plurality of security assessment data elements is a null value.

18. The method of claim 15, wherein the information technology service management data elements include one or more data elements chosen from the set of:
an application inventory data element; or
a service management data element.

19. The method of claim 15, wherein the identity and access management data elements include one or more data elements chosen from the set of:
number of users; or
onboarding status.

20. The method of claim 15, wherein the third-party management data elements include one or more data elements chosen from the set of:
linked third-party engagements and associated risk ratings;
third-party information types; or
third-party issues.

21-40. (canceled)
